(19) United States
(12) Patent Application Publication
(10) Pub. No.: US 2016/0378949 A1
(43) Pub. Date: Dec. 29, 2016

(54) SYSTEM, METHOD, AND APPARATUS FOR ELECTRONIC PRESCRIPTION

(71) Applicant: ALIBABA GROUP HOLDING LIMITED, George Town (KY)

(72) Inventors: Yingfang FU, Beijing (CN); Shuanlin LIU, Beijing (CN)

(73) Assignee: ALIBABA GROUP HOLDING LIMITED

(21) Appl. No.: 15/192,156

(22) Filed: Jun. 24, 2016

(30) Foreign Application Priority Data
Jun. 26, 2015 (CN) 201510362427.0

(51) Int. Cl. G06F 19/00; H04L 9/08; H04L 29/06

(52) U.S. Cl. CPC G06F 19/3456; H04L 63/06; H04L 63/10; H04L 9/0852; G06Q 2220/00

(57) ABSTRACT

A method for electronic prescription operation is disclosed. The method may be implemented by an electronic prescription management system. The method may comprise obtaining, by an electronic prescription management system, an electronic prescription operation request of a user from a client terminal; encrypting, by the electronic prescription management system and according to the operation request, private data of the user with a shared quantum key; and transmitting, by the electronic prescription management system, the encrypted private data to a destination device according to the operation request, wherein the shared quantum key is negotiated and acquired in advance by the electronic prescription management system and the destination device based on a quantum key distribution protocol.

### CROSS REFERENCE TO RELATED APPLICATION

The present application is based on and claims the benefits of priority to Chinese Application No. 201510362427.0, filed Jun. 26, 2015, the entire contents of which are incorporated herein by reference.

### TECHNICAL FIELD

The present application relates to methods, apparatus, and systems for electronic prescription.

### BACKGROUND

Development of cloud computing and Internet technologies have spurred telemedicine. Medical institutions, especially those with relatively poor conditions and quality, have a demand for remote services from professionals in some large-scale hospitals that specialize in certain practices or have better resources. Patients have a demand for purchasing prescription drugs from pharmacies by cloud computing and Internet technologies, in order to reduce medical costs. In addition, patients in rural and far-flung areas may also have a demand for remote medical services from medical institutions in large cities.

In light of the above, electronic prescription management systems (also referred to as an electronic prescription platforms) emerge. Through the electronic prescription platform, a user can bind an identifier registered at the electronic prescription platform to a patient identifier registered at a hospital information system (the patient management system provided by medical institutions), acquire an electronic prescription provided by the hospital information system, and authorize a third party to access/check the electronic prescription. However, protecting user private data and authentication/authorization on the electronic prescription management system may not be easy.

To avoid having user private data, for example, user name, ID number, mobile phone number, and other information included in an electronic prescription, maliciously attacked or stolen, the electronic prescription and other user privacy information transmitted via a network are generally protected by using an encryption based on a classical key. In some cases, the following problems may exist. If symmetric keys are used for protection, key distribution may be difficult. If a public key encryption is used, although a key distribution process is not necessary, an operational speed is slow and the efficiency is hard to meet practical needs. Moreover, the above all belong to privacy protection mechanisms based on a classical cryptography, all of which have potential safety issues of being cracked, in light of rapid advances in computing capability of cloud computing, quantum computing, and the like.

In order to improve operation security, the electronic prescription management system needs to perform authentication and authorization on various parties that participate in an electronic prescription operation. For the purpose of privacy protection, the electronic prescription management system generally does not store real name information of users and other participants, and cannot perform real name authentication by itself. Thus, the electronic prescription management system generally seeks for a third party authority to perform authentication. However, since the electronic prescription management system and various parties interact frequently in the electronic prescription operation, operation steps will become too complicated to be efficient, if the electronic prescription management system uses the above-described mechanisms to perform authentication.

### SUMMARY

One aspect of the present disclosure is directed to a method for electronic prescription operation is disclosed. The method may be implemented by an electronic prescription management system. The method may comprise obtaining, by an electronic prescription management system, an electronic prescription operation request of a user from a client terminal; encrypting, by the electronic prescription management system and according to the operation request, private data of the user with a shared quantum key; and transmitting, by the electronic prescription management system, the encrypted private data to a destination device according to the operation request, wherein the shared quantum key is negotiated and acquired in advance by the electronic prescription management system and the destination device based on a quantum key distribution protocol.

Another aspect of the present disclosure is directed to an electronic prescription management apparatus. The electronic prescription management apparatus may comprises a memory that stores a set of instructions and one or more hardware processors configured to execute the set of instructions to: obtain an electronic prescription operation request of a user from a client terminal; encrypt, according to the operation request, private data of the user with a shared quantum key; and transmit the encrypted private data to a destination device according to the operation request, wherein the shared quantum key is negotiated and acquired in advance by the electronic prescription management system and the destination device based on a quantum key distribution protocol.

Another aspect of the present disclosure is directed to a non-transitory computer-readable storage medium storing one or more programs that, when executed by a processor of an electronic prescription management system, cause the electronic prescription management system to perform an electronic prescription operation, the method comprising: obtaining, by an electronic prescription management system, an electronic prescription operation request of a user from a client terminal; encrypting, by the electronic prescription management system and according to the operation request, private data of the user with a shared quantum key; and transmitting, by the electronic prescription management system, the encrypted private data to a destination device according to the operation request, wherein the shared quantum key is negotiated and acquired in advance by the electronic prescription management system and the destination device based on a quantum key distribution protocol.

Additional features and advantages of the present disclosure will be set forth in part in the following detailed description, and in part will be obvious from the description, or may be learned by practice of the present disclosure. The features and advantages of the present disclosure will be realized and attained by means of the elements and combinations particularly pointed out in the appended claims.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this specification, illustrate several embodiments and, together with the description, serve to explain the disclosed principles.

FIG. 1 is a flow diagram illustrating an electronic prescription operation method, according to an exemplary embodiment.

FIG. 2 is a flow diagram illustrating a method of establishing a binding relationship between a user and a HIS system, according to an exemplary embodiment.

FIG. 3 is a schematic diagram illustrating data interaction of a binding operation, according to an exemplary embodiment.

FIG. 4 is a flow diagram illustrating a method of updating a shared key between a user and a HIS system, according to an exemplary embodiment.

FIG. 5 is a schematic diagram illustrating data interaction of a shared key update operation, according to an exemplary embodiment.

FIG. 6 is a flow diagram illustrating a method of a user acquiring an electronic prescription, according to an exemplary embodiment.

FIG. 7 is a schematic diagram illustrating data interaction of an operation of acquiring an electronic prescription when an electronic prescription management system has not stored the electronic prescription, according to an exemplary embodiment.

FIG. 8 is a schematic diagram illustrating data interaction of an operation of acquiring an electronic prescription when an electronic prescription management system has stored the electronic prescription, according to an exemplary embodiment.

FIG. 9 is a flow diagram illustrating a method of a user authorizing a third party to access/check an electronic prescription, according to an exemplary embodiment.

FIG. 10 is a schematic diagram of data interaction illustrating a user authorizing a third party to access/check an electronic prescription for the first time, according to an exemplary embodiment.

FIG. 11 is a schematic diagram of data interaction illustrating a user subsequently authorizing a third party to access/check an electronic prescription, according to an exemplary embodiment.

FIG. 12 is a block diagram of an electronic prescription operation apparatus, according to an exemplary embodiment.

FIG. 13 is a flow diagram illustrating a request method for establishing a binding relationship, according to an exemplary embodiment.

FIG. 14 is a block diagram illustrating a request apparatus for establishing a binding relationship, according to an exemplary embodiment.

FIG. 15 is a flow diagram illustrating a method for establishing a binding relationship, according to an exemplary embodiment.

FIG. 16 is a block diagram illustrating an apparatus for establishing a binding relationship, according to an exemplary embodiment.

FIG. 17 is a flow diagram illustrating a method for verifying a binding relationship, according to an exemplary embodiment.

FIG. 18 is a block diagram illustrating an apparatus for verifying a binding relationship, according to an exemplary embodiment.

FIG. 19 is a flow diagram illustrating a request method for updating a shared key, according to an exemplary embodiment.

FIG. 20 is a block diagram illustrating a request apparatus for updating a shared key, according to an exemplary embodiment.

FIG. 21 is a flow diagram illustrating a method for forwarding a shared key update request, according to an exemplary embodiment.

FIG. 22 is a block diagram illustrating an apparatus for forwarding a shared key update request, according to an exemplary embodiment.

FIG. 23 is a flow diagram illustrating a method for updating a shared key, according to an exemplary embodiment.

FIG. 24 is a block diagram illustrating an apparatus for updating a shared key, according to an exemplary embodiment.

FIG. 25 is a flow diagram illustrating a request method for acquiring an electronic prescription, according to an exemplary embodiment.

FIG. 26 is a block diagram illustrating a request apparatus for acquiring an electronic prescription, according to an exemplary embodiment.

FIG. 27 is a flow diagram illustrating a method 2700 for forwarding an electronic prescription, according to an exemplary embodiment.

FIG. 28 is a block diagram illustrating an apparatus for forwarding an electronic prescription, according to an exemplary embodiment.

FIG. 29 is a flow diagram illustrating a method for providing an electronic prescription, according to an exemplary embodiment.

FIG. 30 is a schematic diagram illustrating an apparatus for providing an electronic prescription, according to an exemplary embodiment.

FIG. 31 is a flow diagram illustrating a request method for authorizing a third party, according to an exemplary embodiment.

FIG. 32 is a schematic diagram illustrating a request apparatus for authorizing a third party, according to an exemplary embodiment.

FIG. 33 is a flow diagram illustrating an electronic prescription forwarding method for authorizing a third party, according to an exemplary embodiment.

FIG. 34 is a schematic diagram illustrating an electronic prescription forwarding apparatus for authorizing a third party according to the present application.

FIG. 35 is a flow diagram illustrating a method for acquiring an authorized prescription, according to an exemplary embodiment.

FIG. 36 is a schematic diagram illustrating an apparatus for acquiring an authorized prescription, according to an exemplary embodiment.

FIG. 37 is a block diagram illustrating an electronic prescription operation system, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention as recited in the appended claims.

In this disclosure, an electronic prescription operation method and apparatus, a request method and apparatus for establishing a binding relationship, a method and apparatus for establishing a binding relationship, a method and apparatus for verifying a binding relationship, a request method and apparatus for updating a shared key, a method and apparatus for forwarding a shared key update request, a method and apparatus for updating a shared key, a request method and apparatus for acquiring an electronic prescription, a method and apparatus for forwarding an electronic prescription, a method and apparatus for providing an electronic prescription, a request method and apparatus for authorizing a third party, an electronic prescription forwarding method and apparatus for authorizing a third party, a method and apparatus for acquiring an authorized prescription and an electronic prescription operation system are disclosed respectively, which are described in detail with respect to the following embodiments.

A method of performing an electronic prescription operation between a client terminal, an electronic prescription management system, a hospital information system, and a third party under the protection of a shared quantum key is disclosed. The client terminal may be a device that initiates an electronic prescription operation request in accordance with a demand of a user, and that one-to-one corresponds to a user that initiates an electronic prescription operation request. The electronic prescription management system, e.g., an Electronic Prescription Platform (EPP), may be configured to store user electronic prescriptions acquired from the hospital information system, and provide an electronic prescription for a user or a third party in accordance with a demand of a client terminal. The Hospital Information System (HIS) may be a device system run by a medical institution (for example, a hospital) and configured to store information of users who accept medical care services (for example, those seeing a doctor and having health physical examinations). The information of users may include user personal information and information of accepted medical care services, for example, electronic prescriptions prescribed by a doctor and the like. The third party may be a participant that needs to check/use a user electronic prescription through an electronic prescription platform, for example, a pharmacy, a medicine supervision institution, and the like. The third part may be a device or a device system.

When accepting a medical care service from a medical institution, a user may perform initial registration in the medical institution, and store real personal information in an HIS system of the medical institution. Correspondingly, the HIS system can generate a unique identifier, e.g., Patient_ID, for the user, which is called patient identifier in this disclosure. In the process of initializing the registration, secret verification information, e.g., the shared key between the user and the HIS system, can be set and the shared key can be stored in association with the Patient_ID in the HIS system. After this, each time the user accepts a medical care service from the medical institution, the HIS system may generate a corresponding electronic prescription, which can be stored in the HIS system.

The user can register at the electronic prescription management system, and obtain a unique identifier of the user User_ID and a login password. Similarly, the HIS system of the medical institution and the third party may also register at the electronic prescription management system. After the registration, the user can log in to the electronic prescription management system through a client terminal. Each of the client terminal, the HIS system, and the third party can negotiate with the electronic prescription management system to obtain a shared quantum key through a quantum key distribution protocol, and use the shared quantum key to protect private data in an electronic prescription operation. Exemplary embodiments of the disclosure are described below.

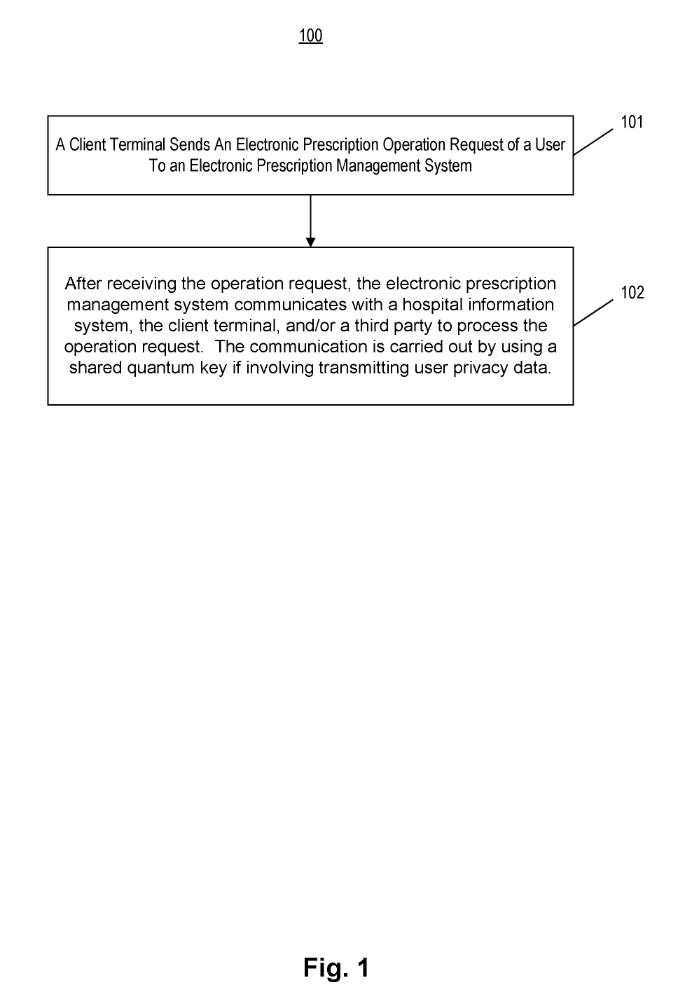

FIG. 1 is a flow diagram illustrating an electronic prescription operation method 100, according to an exemplary embodiment. Method 100 may be implemented by a non-transitory computer-readable medium storing one or more programs, the one or more programs comprising instructions which, when executed by a processor of a computer system, cause the computer system to perform method 100. Method 100 may include a number of steps, some of which may be optional:

Step 101. A client terminal sends an electronic prescription operation request of a user to an electronic prescription management system.

Step 102. After receiving the operation request, the electronic prescription management system communicates with a hospital information system, the client terminal, and/or a third party to process the operation request. The communication is carried out by using a shared quantum key if involving transmitting user private data.

Between parties processing the electronic prescription operation request, a sender of the user private data may use a shared quantum key for encryption, and a receiver of the user private data may correspondingly use the shared quantum key for decryption. The shared quantum key can be negotiated and acquired in advance by the sender and the receiver through a quantum key distribution protocol. In this embodiment, the user private data may include one or a combination of the following elements: a shared key between the user and the hospital information system, an electronic prescription of the user, and a shared key between the user and the third party. Other user private data to be protected may also be determined according to specific needs.

The user private data can be protected by using a quantum key in the transmission process. Since the quantum key, being a symmetric key, has a good encryption and decryption execution efficiency, security of a key distribution process is protected based on the basic principle of quantum mechanics, and there is no potential safety breach like the classical password being cracked, security of the user private data can be effectively protected. In addition, since the shared quantum key is negotiated and obtained by both parties of interaction through a quantum key distribution protocol, while only two parties having a shared quantum key can perform correct encryption and decryption operations, the shared quantum key can verify identities of the both parties of interaction, thus achieving anonymous authentication, simplifying authentication and authorization processes, and increasing the execution efficiency.

Further, before the client terminal or the hospital information system uses a shared quantum key to encrypt user private data to be sent to the electronic prescription management system, the user private data can be encrypted such that the electronic prescription management system cannot decrypt. Thus, the electronic prescription management system, when performing storing or forwarding information, may not obtain the user private data, thereby avoiding leakage of the user private data. For example, the HIS system may send an electronic prescription to the client terminal via the electronic prescription management system. The HIS system can first encrypt the electronic prescription by using a shared key between the HIS system and the user, and then further encrypt the electronic prescription by using a shared quantum key between the HIS system and the electronic prescription management system. Thus, after receiving the electronic prescription with two layers of encryption, although the electronic prescription management system may decrypt one layer of the encryption of the electronic prescription by using the corresponding shared quantum key, the electronic prescription is still not fully-decrypted, and private data included in the electronic prescription cannot be obtained. This can further improve the security of the user private data in the process of the electronic prescription operation.

In addition, in order to further improve the security of the electronic prescription operation, data transmission between the parties processing the operation request may be based on HTTPS connection, and digital certificates used by the parties can be issued by a trusted third party. The parties processing the operation request, before negotiating the shared quantum key through the quantum key distribution protocol, can perform two-way identity authentication (for example, by using a preset digital certificate), and start the quantum key negotiation process after the authentication is passed.

In some embodiments, an operation related to the electronic prescription may include one or more of the following four operations: binding the user to the HIS system; updating a shared key between the user and the HIS system; acquiring, by the user, the electronic prescription; and authorizing, by the user, the third party to check the electronic prescription. Hereinafter, exemplary embodiments of the above four operations are described in detail, and in other embodiments, operations related to the electronic prescription may be not merely limited to one or more of the above four steps, and may also include other operations, which are not specifically limited in this disclosure.

In some embodiments, the user private data is protected by using a shared quantum key in the process of interaction. Accordingly, for non-private data, both parties of interaction can determine in advance whether to apply a shared quantum key for protection, and perform corresponding encryption and decryption operations in accordance with an agreement. For example, if it is agreed in advance that the non-private data is also protected by using a shared quantum key, a sender may encrypt both the private and non-private data by using a shared quantum key, and a receiver may correspondingly decrypt such two kinds of data by using the corresponding quantum key. If it is agreed in advance that the non-private data is not protected by using a quantum key, the sender may only encrypt private data by using a shared quantum key, and the receiver correspondingly may only have to decrypt the received private data by using the corresponding shared quantum key, while the non-private data does not need to be decrypted.

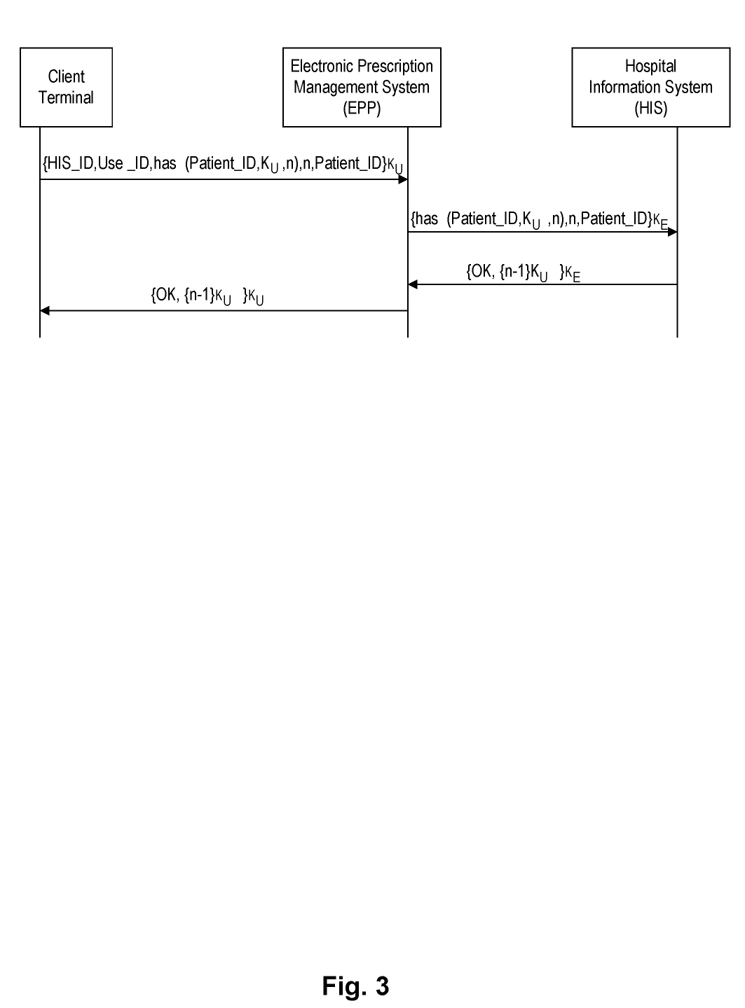

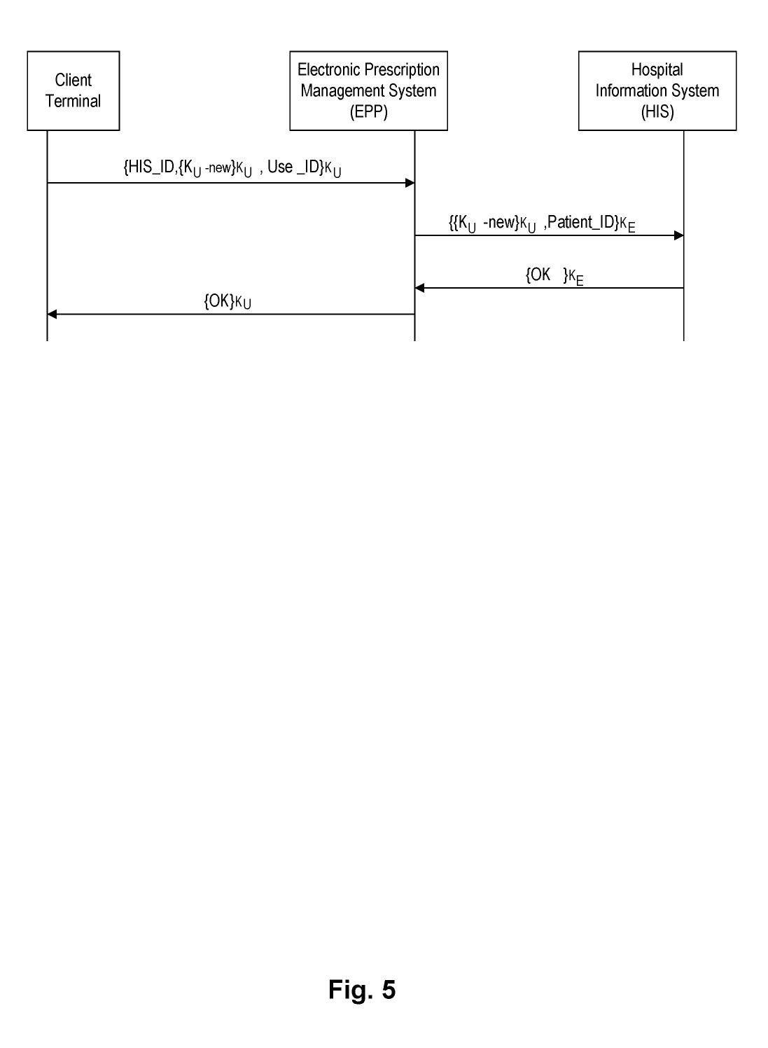

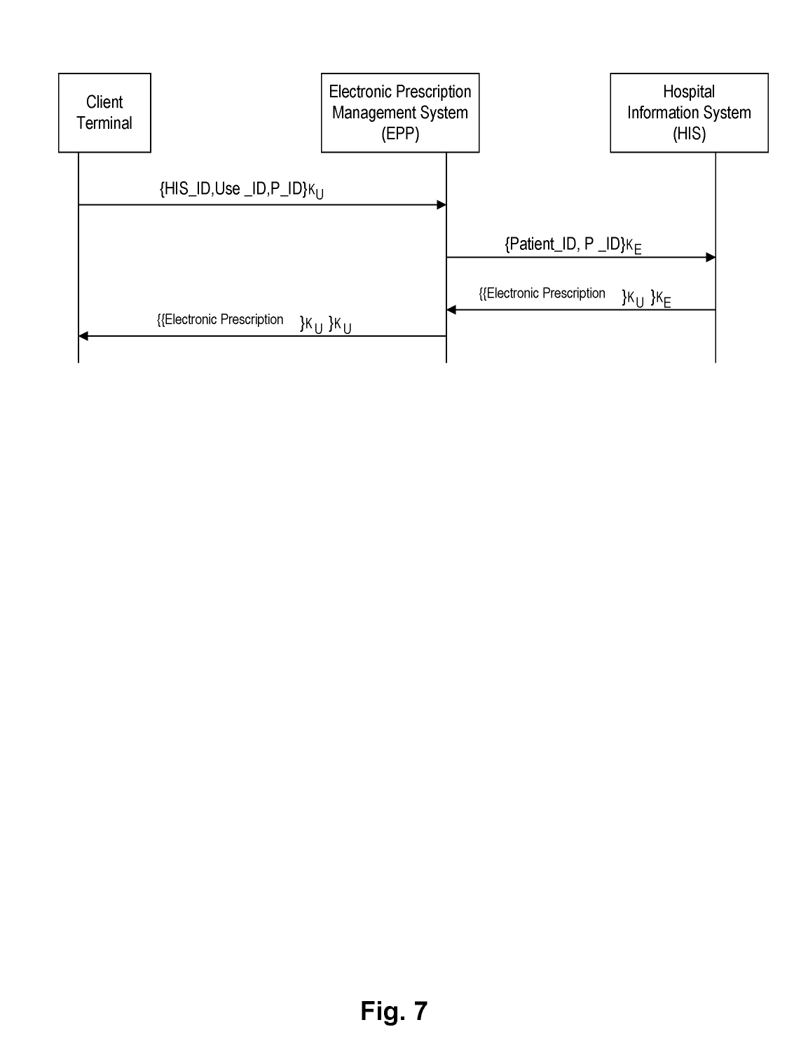

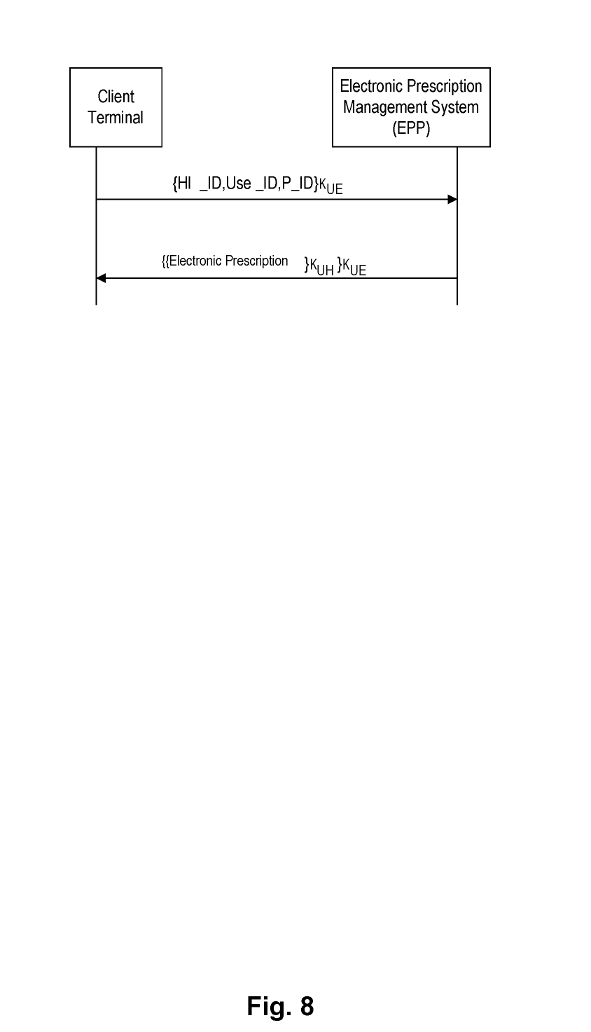

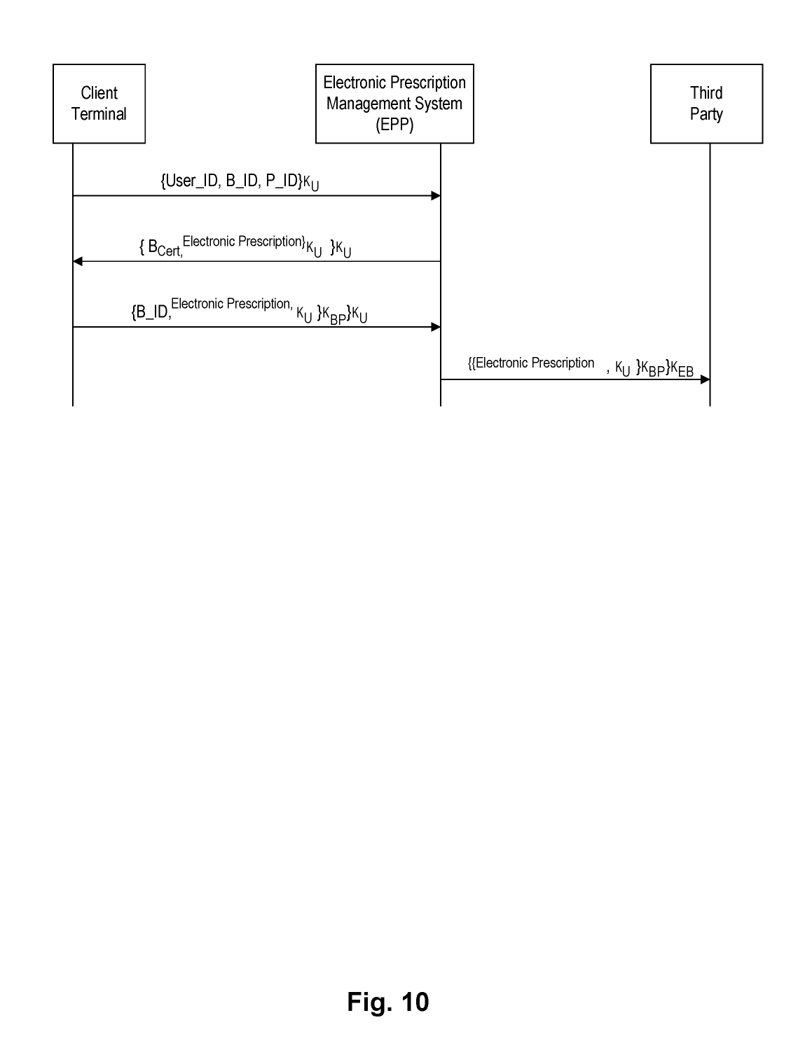

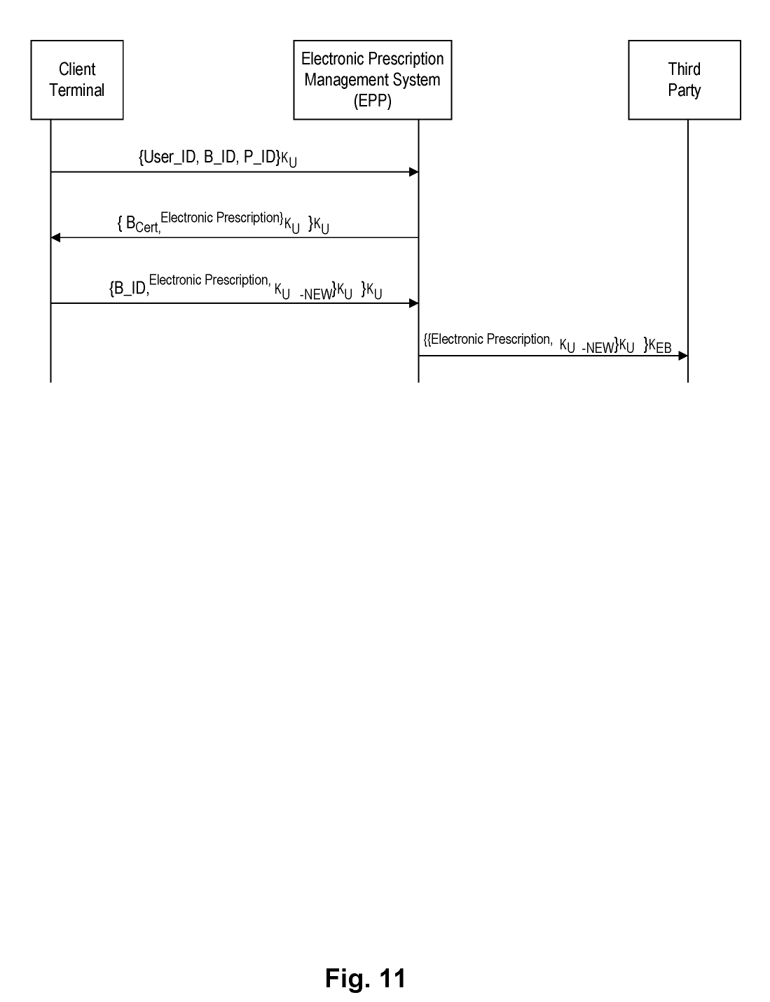

This embodiment may include protecting both user private data and non-private data by using a shared quantum key, e.g., after preparing the data to be sent, the sender of the both parties of interaction can encrypt the data by using a shared quantum key between the sender and the receiver, and the receiver, after receiving the data, may first decrypt the data by using the corresponding shared quantum key and then perform further processing for acquired information. FIG. 3, FIG. 5, FIG. 7, FIG. 8, FIG. 10, and FIG. 11 illustrate the processing process of this part.

The electronic prescription operation flows listed above are disclosed in more details below. In the following description, User_ID may represent an identifier of the user acquired after a user registers at the electronic prescription management system. Patient_ID may represent a unique identifier of the user in the HIS system, which is also called patient identifier. B_ID may represent an identifier of the third party. P _ID may represent an identifier of an electronic prescription provided by the HIS system. HIS_ID may represent an identifier of the hospital information system. K_{UE} may represent a shared quantum key between the client terminal and the electronic prescription management system. K_{EH} may represent a shared quantum key between the electronic prescription management system and the HIS system. K_{UH} may represent a shared quantum key between the client terminal and the HIS system. K_{UB} may represent a shared quantum key between the client terminal and the third party. {message}key may represent encryption on a message by using a key. hash( ) may represent a hash function.

(I) A binding relationship between the user and the HIS system is established.

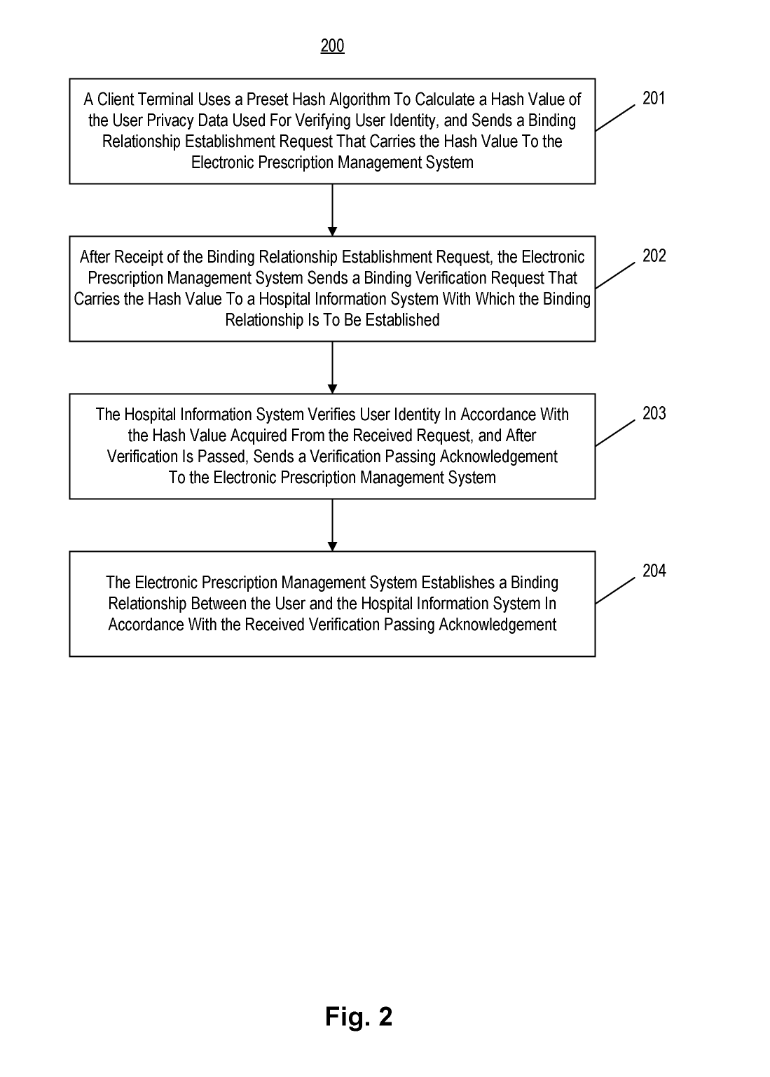

FIG. 2 is a flow diagram illustrating a method 200 of establishing a binding relationship between a user and a HIS system, according to an exemplary embodiment. Method 200 may be implemented by a non-transitory computer-readable storage medium storing one or more programs, the one or more programs comprising instructions which, when executed by a processor of a computer system, cause the computer system to perform method 200. Method 200 may include a number of steps, some of which may be optional:

Step 201. A client terminal uses a preset hash algorithm to calculate a hash value of the user private data used for verifying user identity, and sends a binding relationship establishment request that carries the hash value to the electronic prescription management system.

The client terminal can receive user private data inputted by the user and used for verifying user identity, and after the user logs in, acquire preset user private data used for verifying user identity from locally stored user information. The preset hash algorithm may include: SHA-1, SHA-2, or SHA-3 algorithm.

In this embodiment, the user private data can be a shared key between the user and a HIS system where a binding relationship is to be established. For example, hash(K_{UH}) can be calculated. For another example, hash(Patient_ID, K_{UH}, n) can be calculated, e.g., a hash value of a character string formed by concatenation of Patient_ID, KUH, and n is calculated. Patient_ID can be a patient identifier of the binding relationship to be established, and n can be auxiliary authentication information generated by the client terminal used for implementing two-way authentication, e.g., a random number input by the user.

The binding relationship establishment request sent by the client terminal to the electronic prescription management system may carry the above hash value obtained through calculation, an identifier User_ID of the user that initiates the request, HIS_ID of the binding relationship to be established, and Patient_ID of the user in the corresponding HIS system.

In some embodiments, in order to achieve efficient and secure two-way authentication, the binding relationship establishment request sent by the client terminal to the electronic prescription management system may also carry the auxiliary authentication information locally generated by the client terminal. In one example, a preferred two-way authentication may be used. In another example, two-way authentication may not be used, and the client terminal may not carry the auxiliary authentication information n in the binding relationship establishment request.

Step 202. After receiving the binding relationship establishment request, the electronic prescription management system sends a binding verification request that carries the hash value to a hospital information system, with which the binding relationship is to be established.

After receiving the binding relationship establishment request, the electronic prescription management system can forward a binding verification request that carries the hash value, the Patient_ID and the auxiliary authentication information n to the corresponding HIS system in accordance with the HIS_ID acquired from the received request.

Step 203. The hospital information system verifies user identity in accordance with the hash value acquired from the received request, and after verification is passed, sends a verification passing acknowledgement to the electronic prescription management system.

The HIS system can search for preset user private data used for verifying user identity in accordance with the received Patient_ID. In one embodiment, the HIS system may search for a shared key stored corresponding to the Patient_ID, e.g., the shared key K_{UH} between the user corresponding to the Patient_ID and the HIS system. Then, a hash value can be calculated similarly to that of the client terminal. For example, if the client terminal calculates hash(K_{UH}), the HIS system may also calculate a hash value of K_{UH} found locally. If the client terminal calculates hash(Patient_ID, K_{UH}, n), the HIS system may also correspondingly calculate a hash value by using K_{UH} found locally and received information. The hash value obtained through calculation may be compared with the received hash value. If they are consistent with each other, it may indicate that the Patient_ID provided by the user is valid and legal, and the user may know the shared key corresponding to the Patient_ID. Therefore, it can be determined that the user passes identity verification, and a binding relationship between the user and the HIS system can be established.

After the verification is passed, the HIS system may send a verification passing acknowledgement to the electronic prescription management system. In order to perform a two-way identity verification, the HIS system can generate corresponding variant information in accordance with the received auxiliary authentication information, encrypt the variant information by using K_{UH}, and then send the encrypted variant information to the electronic prescription management system through the verification passing acknowledgement. The variant information of the auxiliary authentication information may include information generated based on the auxiliary authentication information. For example, the variant may be the auxiliary authentication information, or a result obtained by processing the auxiliary authentication information with a preset mathematical transformation method, e.g., n-1.

Step 204. The electronic prescription management system establishes a binding relationship between the user and the hospital information system in accordance with the received verification passing acknowledgement.

After receiving the verification passing acknowledgement, the electronic prescription management system can establish a mapping relationship between the User_ID, the HIS_ID, and the Patient_ID to complete a binding operation. Afterwards, a binding success acknowledgement can be returned to the client terminal.

In order to achieve the two-way identity verification, the electronic prescription management system, when returning the binding success acknowledgement to the client terminal, can carry variant information (variant information encrypted by using K_{UH}) received from the HIS system. After receiving the binding success acknowledgement, the client terminal may extract the encrypted variant information therefrom, decrypt the variant information by using K_{UH}, and determines whether variant information obtained after decryption is consistent with the variant information of the locally generated auxiliary authentication information. If they are consistent with each other, it may indicate that the HIS system can successfully decrypt and restore the auxiliary authentication information n, and the algorithm generating the variant information is consistent with that of the client terminal. Moreover, the variant information may be encrypted with K_{UH}, which can only be obtained by a legal HIS system. Thus, the client terminal can also verify the identity of the HIS system, achieving two-way verification in the binding process. Upon completion of the above two-way verification process, the client terminal can confirm that the binding operation is successful.

FIG. 3 is a schematic diagram illustrating data interaction of a binding operation, according to an exemplary embodiment.

Through a binding process, the electronic prescription management system can establish a mapping relationship between the identifier of the user User_ID of the system and the patient identifier Patient_ID of the HIS system. In the prior art, in order to complete the foregoing binding operation, the electronic prescription management system may need to acquire user private data from the client terminal and the HIS system and perform a comparison, to verify user identity. In the process, the electronic prescription management system may need to acquire user private data, and the private data may be stolen in a transmission process, so that user privacy becomes exposed.

The binding process disclosed in this disclosure may be protected by a shared quantum key in the process of private data transmission, and may use a two-level encryption at the client terminal. For example, before the shared quantum key K_{UE} is used for encryption, the client terminal may use a hash algorithm to encrypt the private data once, and the electronic prescription management system, in the process of forwarding the binding verification request, cannot get the user private data through one decryption, and thus the user private data can be secured in the whole processing process, and unnecessary leakage may not occur. In addition, by returning auxiliary authentication information encrypted by the shared key K_{UH}, the client terminal can confirm information fed back by a legal hospital with which a binding relationship is to be established. Thus, an efficient two-way authentication can be achieved.

(II) A shared key between the user and the HIS system is updated.

A shared key K_{UH} between the user and the hospital information system can be generated offline when the user registers at a medial institution for the first time. The shared key can serve as a basis of two-way authentication when a binding relationship is established between the user and the HIS system, and can also be used to protect private data in an electronic prescription, and thus the shared key can be updated to ensure security. Detailed description of this part is described with reference to user acquiring an electronic prescription.

The client terminal and the HIS system can directly make use of a quantum key distribution protocol to negotiate and acquire a new shared key K_{UH-new} between the user and the HIS system. Such mechanism may require the client terminal to carry out a quantum key negotiation with each HIS system, and may increase overhead costs. With both the client terminal and the HIS system respectively share quantum keys K_{UE} and K_{EH} with the electronic prescription management system, updating of the shared key between the user and the HIS system based on forwarding by electronic prescription management system can save the costs.

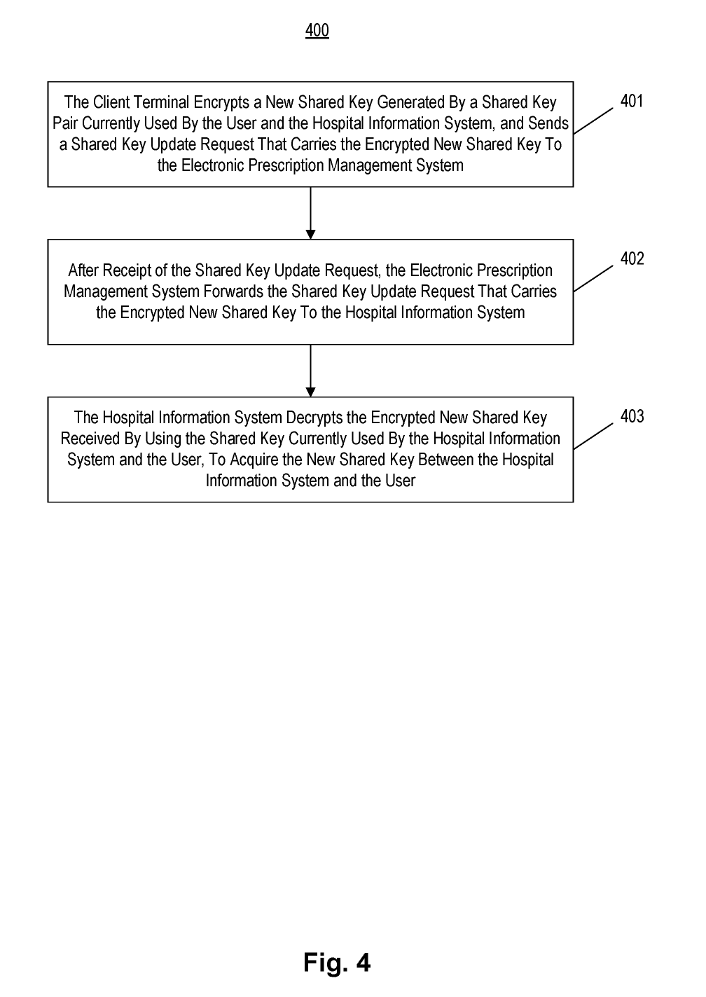

FIG. 4 is a flow diagram illustrating a method 400 of updating a shared key between a user and a HIS system, according to an exemplary embodiment. Method 400 may be implemented by a non-transitory computer-readable storage medium storing one or more programs, the one or more programs comprising instructions which, when executed by a processor of a computer system, cause the computer system to perform method 400. Method 400 may include a number of steps, some of which may be optional:

Step 401. The client terminal encrypts a new shared key generated by a shared key pair currently used by the user and the hospital information system, and sends a shared key update request that carries the encrypted new shared key to the electronic prescription management system.

In some embodiments, the client terminal may generate a new shared key K_{UH-new} between the user and a hospital information system by generating a random number, and encrypt the K_{UH-new} by using the K_{UH} currently used by the user and the hospital information system.

The shared key update request sent by the client terminal to the electronic prescription management system can carry the new shared key K_{UH-new} encrypted by using the K_{UH}, an identifier User_ID of the user that initiates the request, and an identifier HIS_ID of the HIS system where the shared key is to be updated.

Step 402. After receiving the shared key update request, the electronic prescription management system forwards the shared key update request that carries the encrypted new shared key to the hospital information system.

The electronic prescription management system, after acquiring the User_ID, the HIS_ID, and the encrypted K_{UH-new} from the received shared key update request, may search for Patient_ID corresponding to the User_ID and the HIS_ID in accordance with a pre-established binding relationship between the user and the hospital information system, and then, in accordance with the acquired HIS_ID, forward the shared key update request that carries the encrypted K_{UH-new} and the Patient_ID to the corresponding HIS system.

Step 403. The hospital information system decrypts the encrypted new shared key received with the shared key currently used by the hospital information system and the user, to acquire the new shared key between the hospital information system and the user.

The HIS system, after acquiring the encrypted K_{UH-new} and the Patient_ID from the received shared key update request, may search for a shared key K_{UH} stored corresponding to the Patient_ID, and then use the K_{UH} to decrypt the received encrypted K_{UH-new}, to acquire the new shared key K_{UH-new} corresponding to the Patient_ID, e.g., a new shared key between the HIS system and the user corresponding to the Patient_ID. Afterwards, the HIS system can return an acknowledgement of acquisition of the new shared key to the electronic prescription management system, and the electronic prescription management system can return the acknowledgement to the client terminal.

FIG. 5 is a schematic diagram illustrating data interaction of a shared key update operation, according to an exemplary embodiment.

The shared key update process disclosed, under the secure transmission protection provided by the quantum keys K_{UE} and K_{EH}, may achieve an end-to-end shared key update process between the user and the hospital information system through forwarding of the electronic prescription management system. This mechanism can reduce the update cost while ensuring secure transmission of the private data, overcome the difficult of distributing symmetric keys and slow operational speeds of using public key encryption, and provide convenience for achieving anonymous storage of the user private data (for example, electronic prescription) by using the symmetric keys.

Further, the client terminal may use a two-level encryption, for example, before an encryption is carried out by using K_{UE}, the new shared key can be encrypted and protected by using the existing shared key between the user and the HIS system, so that the electronic prescription management system, in the forwarding process, may not obtain information of the new shared key, thus avoiding leakage of the user private data and ensuring security of the user private data.

(III) The user acquires an electronic prescription.

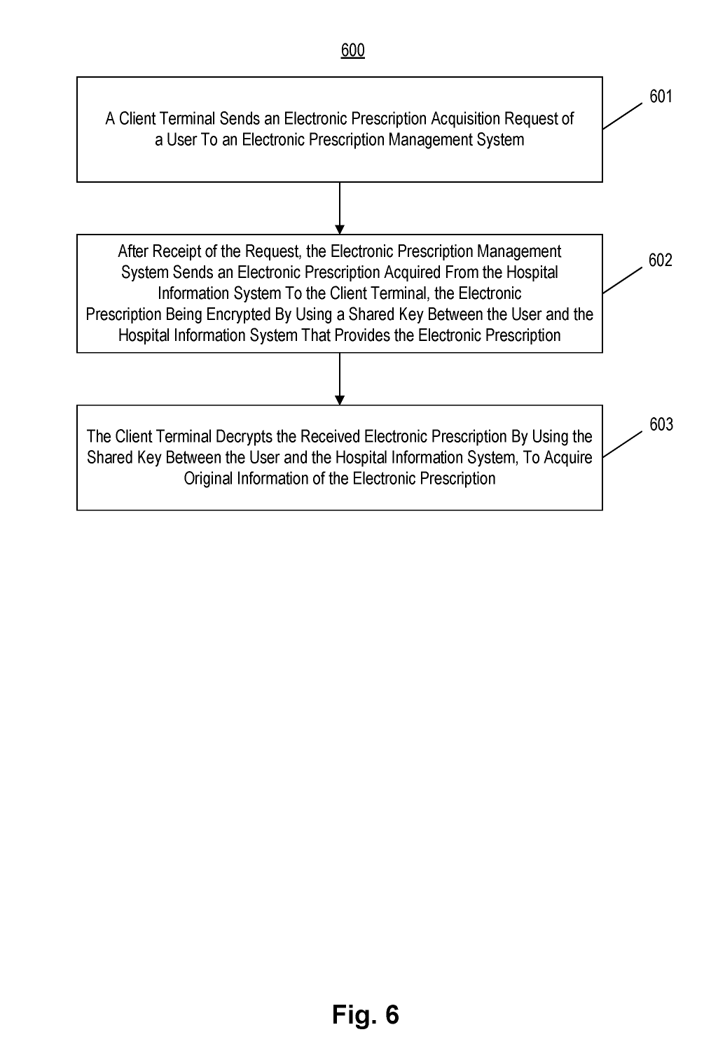

FIG. 6 is a flow diagram illustrating a method 600 of a user acquiring an electronic prescription, according to an exemplary embodiment. Method 600 may be implemented by a non-transitory computer-readable storage medium storing one or more programs, the one or more programs comprising instructions which, when executed by a processor of a computer system, cause the computer system to perform method 600. Method 600 may include a number of steps, some of which may be optional:

Step 601. A client terminal sends an electronic prescription acquisition request of a user to an electronic prescription management system.

The electronic prescription acquisition request sent by the client terminal to the electronic prescription management system can carry an identifier User_ID of the user that initiates the request, an identifier HIS_ID of a hospital information system that provides an electronic prescription, and an identifier P_ID of the electronic prescription.

Step 602. After receiving the request, the electronic prescription management system sends an electronic prescription acquired from the hospital information system to the client terminal, the electronic prescription being encrypted by using a shared key between the user and the hospital information system that provides the electronic prescription.

The electronic prescription management system, after acquiring the User_ID, the HIS_ID, and the P_ID from the received electronic prescription acquisition request, can first verify whether there is a binding relationship between the user and the hospital information system involved in the electronic prescription acquisition request, e.g., whether the Patient_ID corresponding to the User_ID and the HIS_ID exists. If Yes, it may indicate that the corresponding binding relationship has been established, and the operation of acquiring the electronic prescription can be performed. Otherwise, an acknowledgement indicating that the binding relationship has not been established can be returned to the client terminal.

The electronic prescription management system may search for whether an electronic prescription corresponding to the User_ID and the P_ID has been stored, and if Yes, acquire the electronic prescription and send the electronic prescription to the client terminal.

If the electronic prescription management system has not stored the electronic prescription, the following operations can be performed:

1) The electronic prescription management system may search for Patient_ID corresponding to the User_ID and the HIS_ID in accordance with a pre-established binding relationship between the user and the hospital information system, and send an electronic prescription acquisition request that carries the Patient_ID and the P_ID to the corresponding HIS system in accordance with the HIS_ID.

2) The HIS system may search for a corresponding electronic prescription in accordance with the Patient_ID and the P_ID carried in the received electronic prescription acquisition request, encrypt the found electronic prescription by using a shared key K_{UH} corresponding to the Patient_ID, and then send the encrypted electronic prescription to the electronic prescription management system.

3) The electronic prescription management system, after receiving the electronic prescription sent by the HIS system, may send the electronic prescription to the client terminal. The electronic prescription platform can also store the electronic prescription, and establish a corresponding relationship between the User_ID, the P_ID, and the electronic prescription. When the user re-acquires or authorizes the third party to access/check the electronic prescription, the electronic prescription management system can directly return the stored electronic prescription.

The electronic prescription acquired by the electronic prescription management system from the hospital information system can be an electronic prescription encrypted by using the shared key K_{UH} between the user and the HIS system, e.g., a ciphertext of the electronic prescription, and correspondingly, the electronic prescription management system can store the ciphertext of the electronic prescription.

Further, under the protection of the shared quantum keys between the client terminal and the electronic prescription management system and/or between the electronic prescription management system and the hospital information system, the shared key between the user and the HIS system may be updated by being forwarded by the electronic prescription management system. In some embodiments, updating a shared key between the user and the HIS system can be used to update the shared key under the protection of the shared quantum keys K_{UE} and K_{EH}.

Step 603. The client terminal decrypts the received electronic prescription by using the shared key between the user and the hospital information system, to acquire original information of the electronic prescription.

FIG. 7 is a schematic diagram illustrating data interaction of an operation of acquiring an electronic prescription when an electronic prescription management system has not stored the electronic prescription, according to an exemplary embodiment. FIG. 8 is a schematic diagram illustrating data interaction of an operation of acquiring an electronic prescription when an electronic prescription management system has stored the electronic prescription, according to an exemplary embodiment.

The electronic prescription platform, while acquiring an electronic prescription from the HIS system and providing the electronic prescription to the client terminal, can also store the electronic prescription, to simplify the process of providing the electronic prescription next time. Since the electronic prescription includes user private data, which should not be known by related personnel of the electronic prescription management system, the user private data should not be leaked even if information leakage occurs in the electronic platform management system.

Under the protection of secure transmission provided by the quantum keys K_{UE} and K_{EH}, the process of acquiring an electronic prescription can allow the user to acquire, through storing and forwarding by the electronic prescription management system, the electronic prescription through the client terminal. While ensuring secure transmission of the private data, the HIS system may apply a two-level encryption to the electronic prescription, for example, before the encryption is carried out by using the K_{EH}, the electronic prescription can be encrypted and protected by using the shared key K_{UH} between the user and the HIS system. The electronic prescription management system can acquire and store a ciphertext of the electronic prescription, and may not obtain the original information included in the electronic prescription, thus achieving anonymous storage of the electronic prescription, preventing leakage of the user private data, and ensuring security of the user private data.

Further, the shared key K_{UH} for encrypting the electronic prescription under the protection of the shared quantum keys K_{UE} and K_{EH} can be updated, to overcome difficulties in distributing symmetric keys in the process of anonymous storage of the electronic prescription, and slow operational speed when using a public key encryption.

(IV) The user authorizes the third party to access/check the electronic prescription.

Under some circumstances, the user may need to authorize other participants to access/check the electronic prescription, including for example, pharmacies, other medical institutions or medicine supervision institutions and the like. The participants that can only access/check the electronic prescription through authorization are collectively called third parties, and these third parties generally can also register at the electronic prescription management system to become trusted third parties recognized by the electronic prescription management system.

In some embodiments, as described above, the user can use the electronic prescription management system to acquire in advance an electronic prescription that the third party is to be authorized to access/check from the HIS system, and store the electronic prescription.

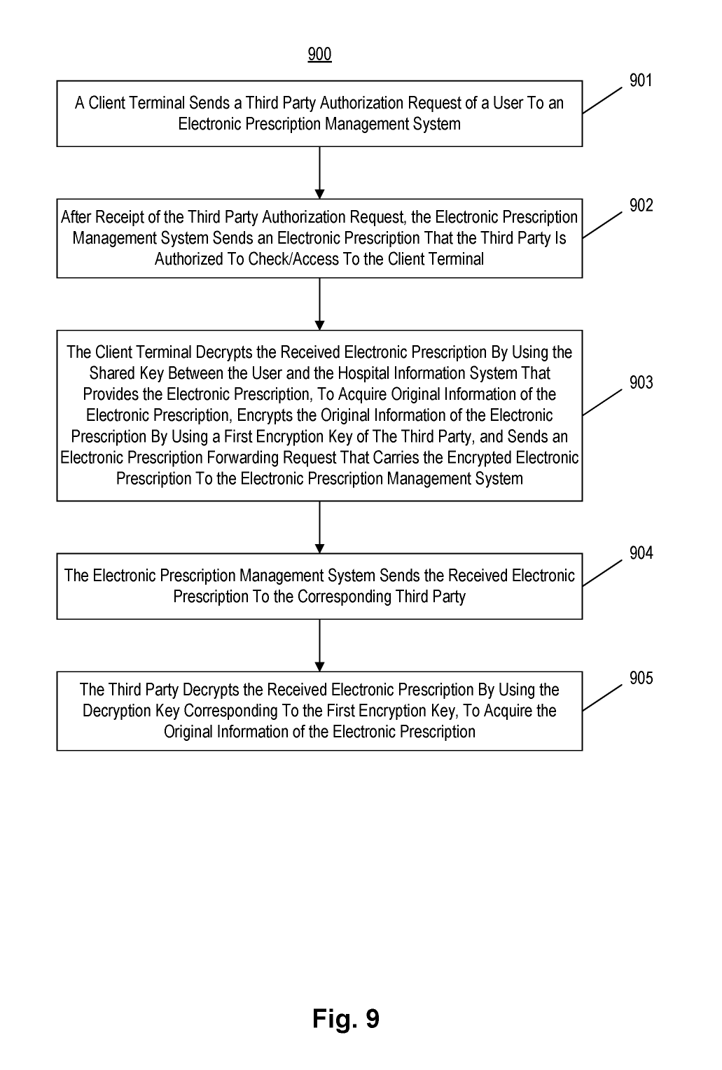

FIG. 9 is a flow diagram illustrating a method 900 of a user authorizing a third party to access/check an electronic prescription, according to an exemplary embodiment. Method 900 may be implemented by a non-transitory computer-readable storage medium storing one or more programs, the one or more programs comprising instructions which, when executed by a processor of a computer system, cause the computer system to perform method 900. Method 900 may include a number of steps, some of which may be optional:

Step 901. A client terminal sends a third party authorization request of a user to an electronic prescription management system.

The third party authorization request sent by the client terminal to the electronic prescription management system can carry an identifier User_ID of a user that initiates the request, an identifier B_ID of the authorized third party, and an identifier P_ID of the electronic prescription that the third party is authorized to access/check.

Step 902. After receiving the third party authorization request, the electronic prescription management system sends an electronic prescription that the third party is authorized to check/access to the client terminal.

After acquiring the User_ID, the B_ID, and the P_ID from the received third party authorization request, the electronic prescription management system can first verify whether the user involved in the request has permission to authorize the third party to access/check the corresponding electronic prescription, e.g., whether the User_ID and the P_ID have a corresponding relationship. If Yes, it may indicate that the electronic prescription is the electronic prescription of the user, the user has permission to authorize the third party to access/check the electronic prescription, and the electronic prescription has been stored in the electronic prescription management system. Then, the electronic prescription corresponding to the User_ID and the P_ID can be sent to the client terminal.

The electronic prescription stored in the electronic prescription management system can be encrypted by using a shared key between the user and a HIS system that provides the electronic prescription.

If the electronic prescription management system has not stored the electronic prescription, e.g., a corresponding relationship between the User_ID, the P_ID and the electronic prescription has not been established, the electronic prescription management system can return an acknowledgment indicating that the electronic prescription has not been found to the client terminal, to prompt the client terminal to acquire an electronic prescription and authorize the third party to check/access the electronic prescription.

Step 903. The client terminal decrypts the received electronic prescription by using the shared key between the user and the hospital information system that provides the electronic prescription, to acquire original information of the electronic prescription, encrypts the original information of the electronic prescription by using a first encryption key corresponding to a decryption key of the third party, and sends an electronic prescription forwarding a request that carries the encrypted electronic prescription to the electronic prescription management system.

The client terminal may decrypt the received electronic prescription by using the K_{UH} to acquire original information of the electronic prescription, encrypt the original information of the electronic prescription by using a first encryption key corresponding to a decryption key of the third party, and send an electronic prescription forwarding request to the electronic prescription management system. The request may carry an electronic prescription encrypted by using the first encryption key and the identifier B_ID of the third party. The first encryption key may be a public key K_{BP} of the third party, then the corresponding decryption key of the third party may be its private key K_{BS}, in this case. In order to facilitate the client terminal to perform encryption processing, in step 902, the electronic prescription management system can send a digital certificate B_{Cert} of the third party to the client terminal together with the electronic prescription.

As illustrated, when the electronic prescription management system gets information of the electronic prescription, low computing efficiency of the public key encryption can be overcome. In order to increase the computing efficiency, after receiving the electronic prescription sent by the electronic prescription management system, the client terminal may further generate a new shared key between the user and the third party, for example, by generating a random number as a first encryption key for the next time when a third party authorization request between the client terminal and the third party is processed, and sending the new shared key, after being encrypted similarly to the electronic prescription, to the electronic prescription management system together with the electronic prescription.

Thus, when the user authorizes the third party to access/check the electronic prescription for the first time, the client terminal may encrypt the electronic prescription and the new shared key K_{UB} by using a third party public key K_{BP}, which are forwarded to the third party via the electronic prescription management system, so that the third party can also acquire the K_{UB} by carrying out decryption with its private key K_{BS}. When the user authorizes the third party to access/check the electronic prescription for the second time and for each subsequent time, the client terminal can use a shared key K_{UB} currently used between the user and the third party for encryption, and for generating a new shared key K_{UB-NEW} at the same time, as a shared key for a next time when a third party authorization request between the client terminal and the third party is processed. For example, the first encryption key, and correspondingly, the third party may use the K_{UB} to decrypt information forwarded by the electronic prescription management system, to acquire the K_{UB-NEW} as a shared key for a next time when the electronic prescription of the user is decrypted, e.g., a decryption key corresponding to the first encryption key, to achieve dynamic update of the shared key between the user and the third party.

The shared key between the user and the third party can be generated and updated as described, making use of symmetric keys to save the computing cost, and at the same time, because the shared key is updated in each authorization process, security of the shared key can be improved.

Step 904. The electronic prescription management system sends the received electronic prescription to the corresponding third party.

The electronic prescription management system can acquire the identifier B_ID of the third party from the received electronic prescription forwarding request, and send the received electronic prescription to the corresponding third party in accordance with the B_ID. The electronic prescription can be encrypted by the client terminal with the first encryption key.

If dynamically updating the shared key is used in step 903, in this step, the electronic prescription management system may send to the third party the electronic prescription and the new shared key between the user and the third party.

Step 905. The third party decrypts the received electronic prescription by using the decryption key corresponding to the first encryption key, to acquire the original information of the electronic prescription.

The decryption key corresponding to the first encryption key may be the private key K_{BS} of the third party. If dynamically updating the shared key is used in step 903, after the third party decrypts the received information by using the decryption key (which is K_{BS} in first authorization, and is subsequently the shared key acquired last time) corresponding to the first encryption key, the original information of the electronic prescription and the new shared key K_{UB-NEW} are acquired as a decryption key, corresponds to the first encryption key, for a next time when descripting the electronic prescription of the user.

In view of the above, FIG. 10 is a schematic diagram of data interaction illustrating a user authorizing a third party to access/check an electronic prescription for the first time, according to an exemplary embodiment. FIG. 11 is a schematic diagram of data interaction illustrating a user subsequently authorizing a third party to access/check an electronic prescription, according to an exemplary embodiment.

Under the protection of secure transmission provided by the quantum keys K_{UE} and K_{EB}, the operation process that the user authorizes the third party to access/check the electronic prescription may include authorizing the third party to access/check the electronic prescription through forwarding the electronic prescription management system, while ensuring secure transmission of the user private data. Since the client terminal uses a two-level encryption for the electronic prescription, for example, before the encryption is carried out by using the K_{UE}, the electronic prescription can be encrypted and protected by using the first encryption key between the user and the third party, and the electronic prescription management system can acquire and forward a ciphertext of the electronic prescription, but cannot obtain original information included in the electronic prescription, thus preventing leakage of the user private data and ensures security of the user private data.

Further, when the third party is authorized each time, since the shared key between the user and the third party under the protection of the shared quantum keys K_{UE} and K_{EB} can be updated to serve as symmetric keys for the client terminal and the third party in a next authorization operation, the symmetric keys can be used to save the computing cost and, at the same time, improve security of the shared key.

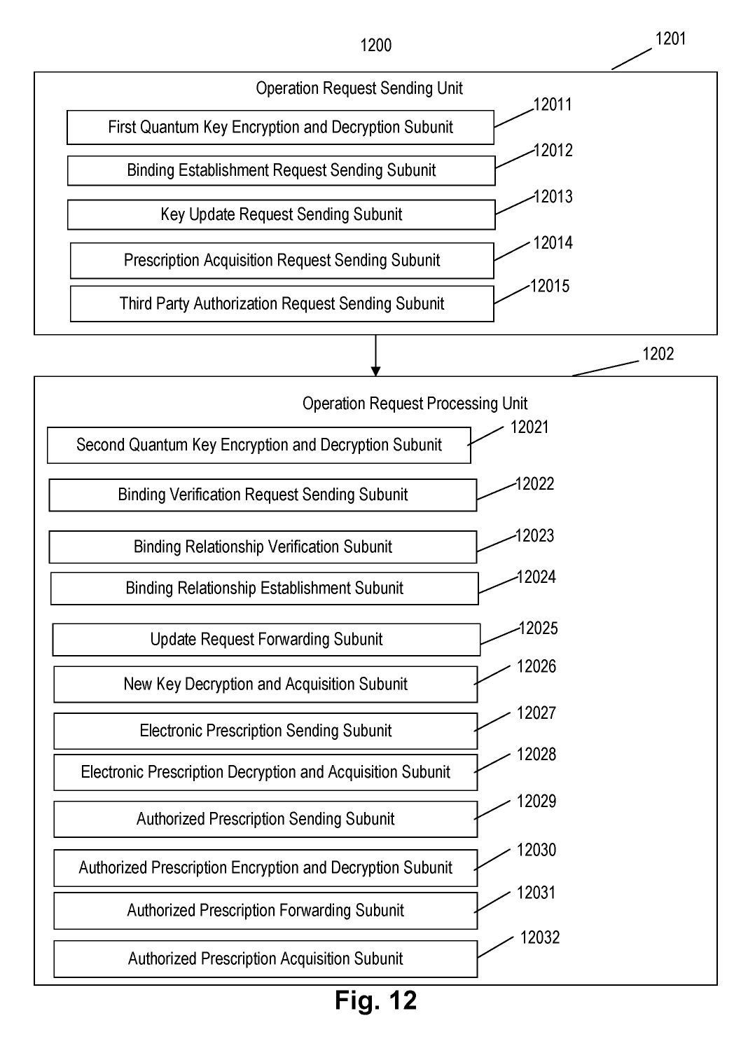

In the above embodiment, an electronic prescription operation method is disclosed. Correspondingly, an electronic prescription operation apparatus is disclosed below. FIG. 12 is a block diagram of an electronic prescription operation apparatus 1200, according to an exemplary embodiment. Since apparatus 1200 is related to the method embodiments described above, it is described in a simpler way, and reference can be made to the corresponding description in the method embodiment for related contents. The apparatus embodiment described below is merely schematic.

Apparatus 1200 may include: an operation request sending unit 1201 configured to obtain, from a client terminal, an electronic prescription operation request of a user to an electronic prescription management system; an operation request processing unit 1202 configured to, encrypt, according to the operation request, private data of the user with a shared quantum key, and transmit, according to the operation request, the encrypted private data to at least one of a hospital information system, the client terminal, or a third party. The shared quantum key is negotiated and acquired in advance by the electronic prescription management system and at least one of the hospital information system, the client terminal, or the third party through a quantum key distribution protocol. The operation request sending unit 1201 may include a first quantum key encryption and decryption subunit 12011 and the operation request processing unit 1202 may include a second quantum key encryption and decryption subunit 12021. Component 12011 and component 12021 may each be configured to, when both parties of interaction participating in the processing the operation request transmit user private data, use a shared quantum key for encryption, and use, by a receiver, the corresponding shared quantum key for decryption. The shared quantum key may be negotiated and acquired in advance by the sender and the receiver through a quantum key distribution protocol.

The operation request processing unit 1202 may be further configured to encrypt, prior to using a shared quantum key to encrypt user private data to be sent to the electronic prescription management system, the user private data, so that the electronic prescription management system cannot decrypt the user private data.

When the electronic prescription operation request is a binding relationship establishment request, the operation request sending unit 1201 may further include:

a binding establishment request sending subunit 12012 configured to use a preset hash algorithm to calculate a hash value of the user private data used for verifying user identity, and send, by the client terminal, a binding relationship establishment request that carries the hash value to the electronic prescription management system; and

correspondingly, the operation request processing unit 1202 may further include:

a binding verification request sending subunit 12022 configured to, after receiving the binding relationship establishment request, send a binding verification request that carries the hash value to a hospital information system where a binding relationship is to be established;

a binding relationship verification subunit 12023 configured to verify user identity in accordance with the hash value acquired from the received request, and after verification is passed, send, by the hospital information system, a verification passing acknowledgement to the electronic prescription management system; and

a binding relationship establishment subunit 12024 configured to establish a binding relationship between the user and the hospital information system in accordance with the received verification passing acknowledgement.

When the electronic prescription operation request is a shared key update request, the operation request sending unit 1201 may further include:

a key update request sending subunit 12013 configured to generate a new shared key between the user and a hospital information system where shared key update is to be carried out, encrypt, by the client terminal, the new shared key by using a shared key currently used by the user and the hospital information system, and send, by the client terminal, a shared key update request that carries the encrypted new shared key to the electronic prescription management system; and

correspondingly, the operation request processing unit 1202 may further include:

an update request forwarding subunit 12025 configured to, after receiving the shared key update request, forward the shared key update request that carries the encrypted new shared key to the hospital information system; and

a new key decryption and acquisition subunit 12026 configured to decrypt the encrypted new shared key received by using the shared key currently used by the hospital information system and the user, to acquire the new shared key between the hospital information system and the user.

When the electronic prescription operation request is an electronic prescription acquisition request, the operation request sending unit 1201 may further include:

a prescription acquisition request sending subunit 12014 configured to send the electronic prescription acquisition request to the electronic prescription management system; and

correspondingly, the operation request processing unit 1202 may further include:

an electronic prescription sending subunit 12027 configured to, after receiving the request, send an electronic prescription acquired from the hospital information system to the client terminal, the electronic prescription being encrypted by using a shared key between the user and the hospital information system that provides the electronic prescription; and

an electronic prescription decryption and acquisition subunit 12028 configured to decrypt the received electronic prescription by using the shared key between the user and the hospital information system, to acquire original information of the electronic prescription.

When the electronic prescription operation request is a third party authorization request, the operation request sending unit 1201 may further include:

a third party authorization request sending subunit 12015 configured to send the third party authorization request to the electronic prescription management system; and

correspondingly, the operation request processing unit 1202 may further include:

an authorized prescription sending subunit 12029 configured to, after receiving the third party authorization request, send an electronic prescription that the third party is authorized to access/check to the client terminal, the electronic prescription being encrypted by using the shared key between the user and the hospital information system that provides the electronic prescription;

an authorized prescription encryption and decryption subunit 12030 configured to decrypt the received electronic prescription by using the shared key between the user and the hospital information system, to acquire original information of the electronic prescription, encrypt, by the client terminal, the original information of the electronic prescription by using a first encryption key corresponding to a decryption key that the third party has, and send, by the client terminal, an electronic prescription forwarding request that carries the encrypted electronic prescription to the electronic prescription management system;

an authorized prescription forwarding subunit 12031 configured to send the encrypted electronic prescription received to the third party; and

an authorized prescription acquisition subunit 12032 configured to decrypt the received electronic prescription by using the decryption key corresponding to the first encryption key, to acquire the original information of the electronic prescription.

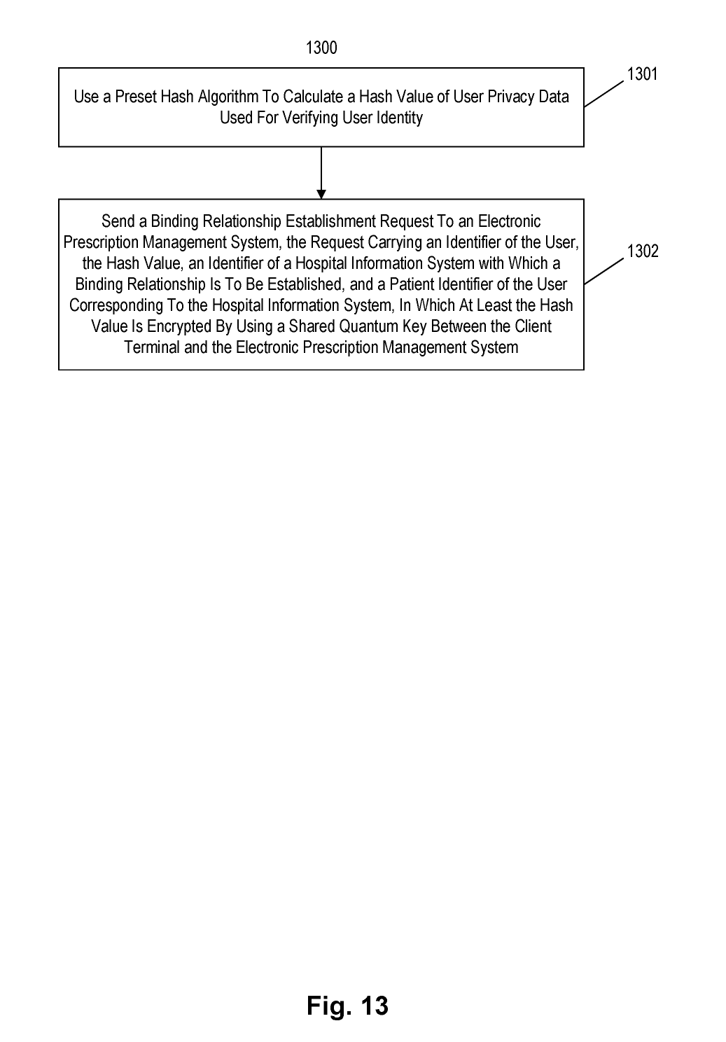

FIG. 13 is a flow diagram illustrating a request method 1300 for establishing a binding relationship, according to an exemplary embodiment. Method 1300 can be implemented at a client terminal. Contents of this embodiment similar to the embodiments described above are no longer repeated, and the following focuses on their differences. Method 1300 may be implemented by a non-transitory computer-readable storage medium storing one or more programs, the one or more programs comprising instructions which, when executed by a processor of a computer system, cause the computer system to perform method 1300. Method 1300 may include a number of steps, some of which may be optional:

Step 1301. A preset hash algorithm is used to calculate a hash value of user private data used for verifying user identity. The user may be a user who initiates a binding relationship establishment request.

Step 1302. A binding relationship establishment request is sent to an electronic prescription management system, the request carrying an identifier of the user, the hash value, an identifier of a hospital information system with which a binding relationship is to be established, and a patient identifier of the user corresponding to the hospital information system, in which at least the hash value is encrypted by using a shared quantum key between the client terminal and the electronic prescription management system.

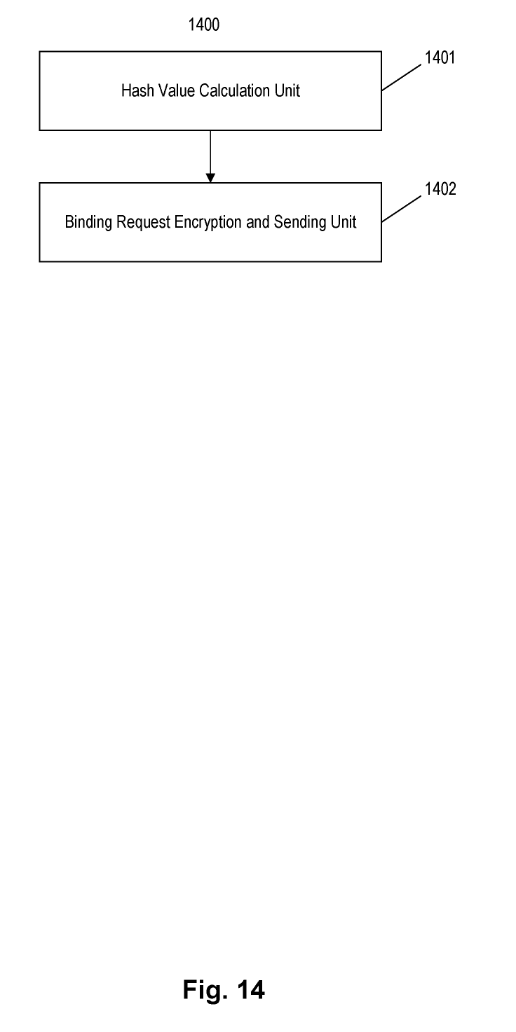

In the above embodiment, a request method for establishing a binding relationship is disclosed. Correspondingly, a request apparatus for establishing a binding relationship is disclosed below. FIG. 14 is a block diagram illustrating a request apparatus 1400 for establishing a binding relationship, according to an exemplary embodiment. The apparatus embodiment described below is merely schematic.

Apparatus 1400 may be deployed at a client terminal and may include: a hash value calculation unit 1401 configured to use a preset hash algorithm to calculate a hash value of user private data used for verifying user identity; and a binding request encryption and sending unit 1402 configured to send a binding relationship establishment request to an electronic prescription management system, the request carrying an identifier of the user, the hash value, an identifier of a hospital information system where a binding relationship is to be established, and a patient identifier of the user corresponding to the hospital information system. At least the hash value may be encrypted by using a shared quantum key between the client terminal and the electronic prescription management system.

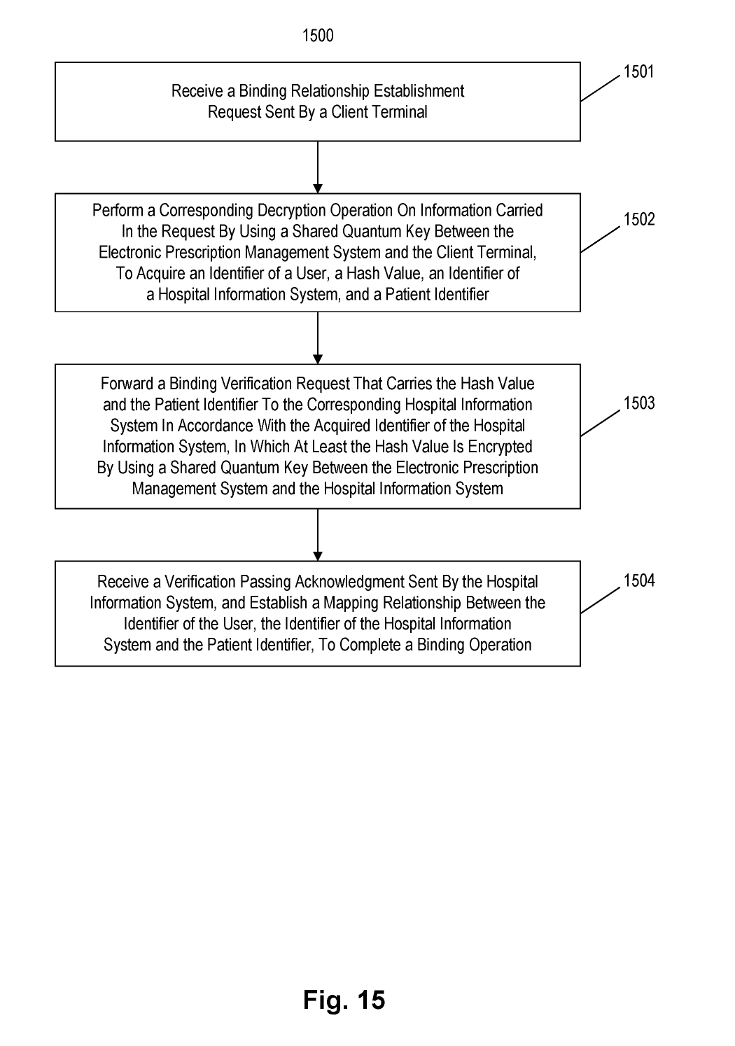

In addition, a method for establishing a binding relationship is disclosed, and the method can be implemented in an electronic prescription management system. FIG. 15 is a flow diagram illustrating a method 1500 for establishing a binding relationship, according to an exemplary embodiment. Contents of this embodiment similar to the embodiments described above are not repeated, and the following focuses on their differences. Method 1500 may be implemented by a non-transitory computer-readable storage medium storing one or more programs, the one or more programs comprising instructions which, when executed by a processor of a computer system, cause the computer system to perform method 1500. Method 1500 may include a number of steps, some of which may be optional:

Step 1501. A binding relationship establishment request sent by a client terminal is received.

Step 1502. A corresponding decryption operation is performed on information carried in the request by using a shared quantum key between the electronic prescription management system and the client terminal, to acquire an identifier of a user, a hash value, an identifier of a hospital information system, and a patient identifier.

Step 1503. A binding verification request that carries the hash value and the patient identifier is forwarded to the corresponding hospital information system in accordance with the acquired identifier of the hospital information system, in which at least the hash value is encrypted by using a shared quantum key between the electronic prescription management system and the hospital information system.

Step 1504. A verification passing acknowledgment sent by the hospital information system is received, and a mapping relationship between the identifier of the user, the identifier of the hospital information system and the patient identifier is established, to complete a binding operation.

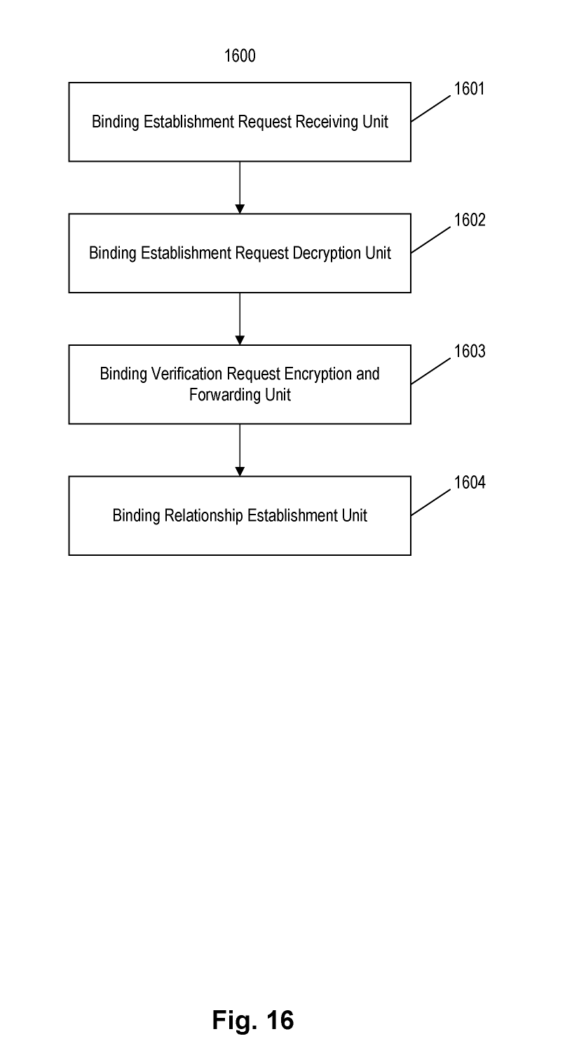

A method for establishing a binding relationship is disclosed. Correspondingly, an apparatus for establishing a binding relationship is disclosed below. FIG. 16 is a block diagram illustrating an apparatus 1600 for establishing a binding relationship, according to an exemplary embodiment. The apparatus embodiment described below is merely schematic.

Apparatus 1600 can be deployed at an electronic prescription management system and may include: a binding establishment request receiving unit 1601 configured to receive a binding relationship establishment request sent by a client terminal; a binding establishment request decryption unit 1602 configured to perform a corresponding decryption operation on information carried in the request by using a shared quantum key between the electronic prescription management system and the client terminal, to acquire an identifier of a user, a hash value, an identifier of a hospital information system, and a patient identifier; a binding verification request encryption and forwarding unit 1603 configured to forward a binding verification request that carries the hash value and the patient identifier to the corresponding hospital information system in accordance with the acquired identifier of the hospital information system, in which at least the hash value is encrypted by using a shared quantum key between the electronic prescription management system and the hospital information system; and a binding relationship establishment unit 1604 configured to receive a verification passing acknowledgment sent by the hospital information system, and to establish a mapping relationship among the identifier of the user, the identifier of the hospital information system, and the patient identifier, to complete a binding operation.

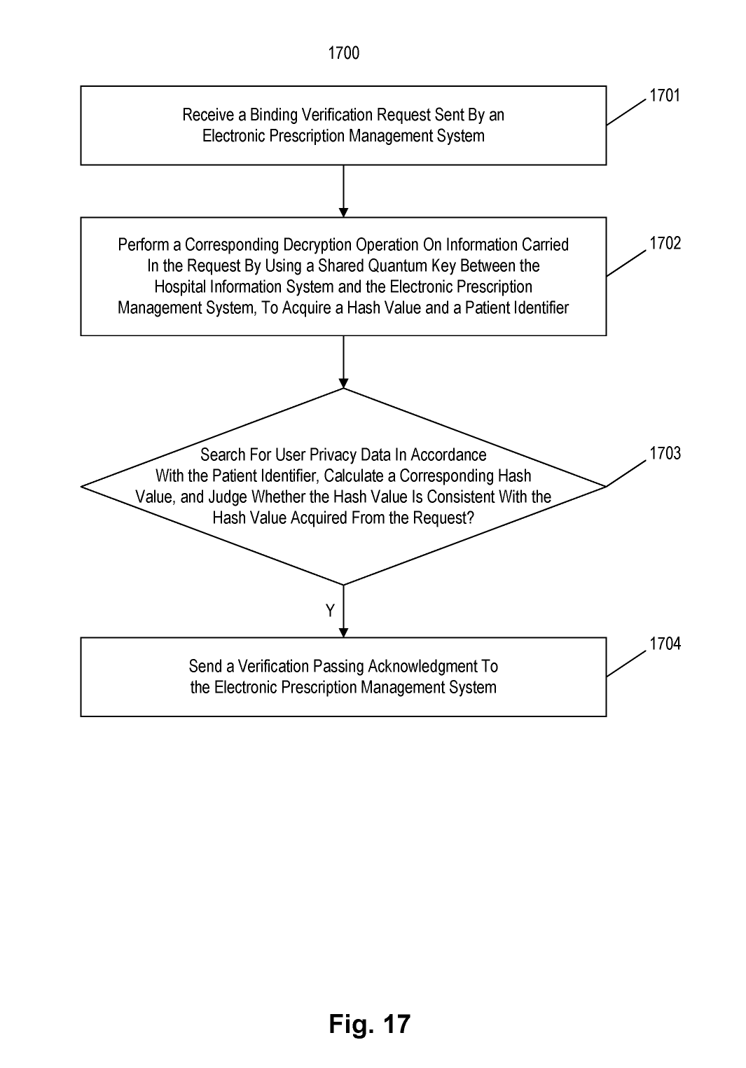

In addition, a method for verifying a binding relationship is disclosed, and the method can be implemented in a hospital information system. FIG. 17 is a flow diagram illustrating a method 1700 for verifying a binding relationship, according to an exemplary embodiment. Contents of this embodiment similar to the embodiments described above are not repeated, and the following focuses on their differences. Method 1700 may be implemented by a non-transitory computer-readable storage medium storing one or more programs, the one or more programs comprising instructions which, when executed by a processor of a computer system, cause the computer system to perform method 1700. Method 1700 may include a number of steps, some of which may be optional:

Step 1701. A binding verification request sent by an electronic prescription management system is received by a hospital information system.

Step 1702. A corresponding decryption operation is performed on information carried in the request by using a shared quantum key between the hospital information system and the electronic prescription management system, to acquire a hash value and a patient identifier.

Step 1703. User private data which is preset and used for verifying user identity is searched in accordance with the received patient identifier, a hash value of the found user private data is calculated by using the preset hash algorithm, and whether the hash value obtained through calculation is consistent with the hash value acquired from the request is determined. If they are consistent with each other, step 1704 can be performed.

Step 1704. A verification passing acknowledgment is sent to the electronic prescription management system.

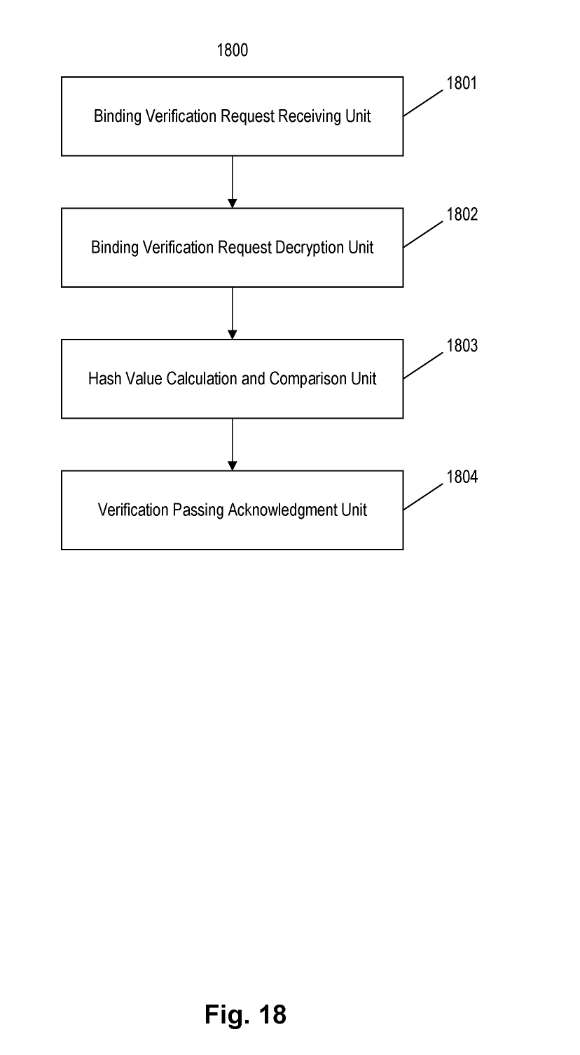

In the above embodiment, a method for verifying a binding relationship is disclosed. Correspondingly, an apparatus for verifying a binding relationship is disclosed below. FIG. 18 is a block diagram illustrating an apparatus 1800 for verifying a binding relationship, according to an exemplary embodiment. The apparatus embodiment described below is merely schematic.

Apparatus 1800 can be deployed at a hospital information system, and may include: a binding verification request receiving unit 1801 configured to receive a binding verification request sent by an electronic prescription management system; a binding verification request decryption unit 1802 configured to perform a corresponding decryption operation on information carried in the request by using a shared quantum key between the hospital information system and the electronic prescription management system, to acquire a hash value and a patient identifier; a hash value calculation and comparison unit 1803 configured to search for user private data which is preset and used for verifying user identity in accordance with the received patient identifier, calculate a hash value of the found user private data by using the preset hash algorithm, and determine whether the hash value obtained through calculation is consistent with the hash value acquired from the request; and a verification passing acknowledgment unit 1804 configured to, when an output of the hash value calculation and comparison unit is Yes, send a verification passing acknowledgment to the electronic prescription management system.

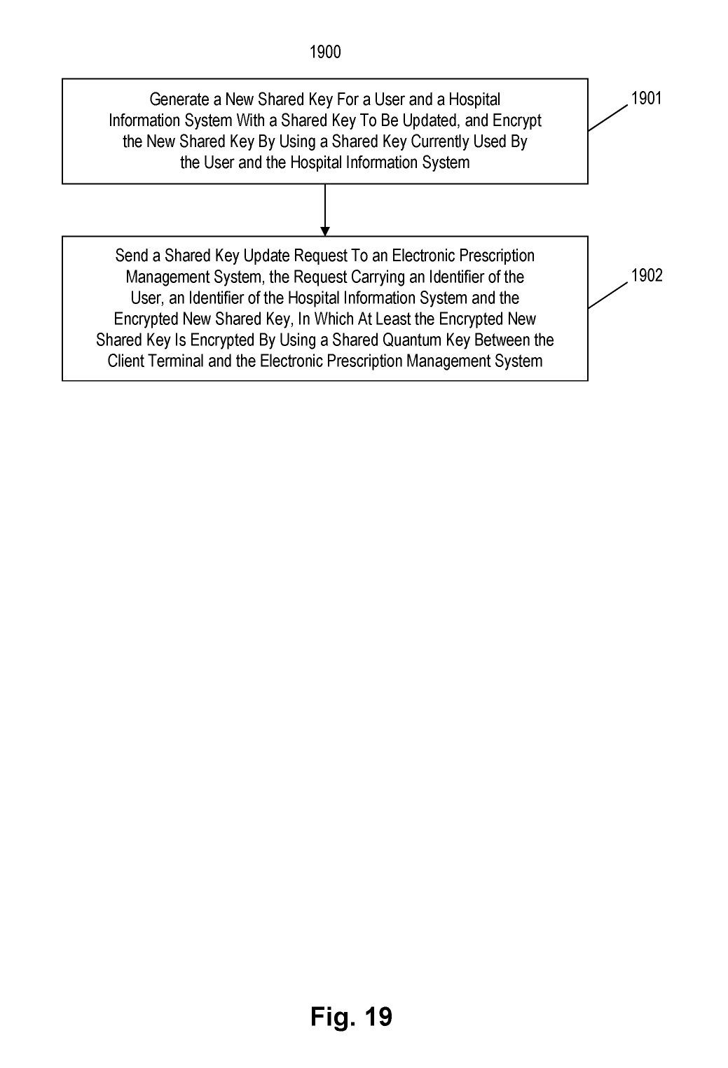

In addition, a request method for updating a shared key is disclosed, and the method can be implemented at a client terminal. FIG. 19 is a flow diagram illustrating a request method 1900 for updating a shared key, according to an exemplary embodiment. Contents of this embodiment similar to the embodiments described above are not repeated, and the following focuses on their differences. Method 1900 may be implemented by a non-transitory computer-readable storage medium storing one or more programs, the one or more programs comprising instructions which, when executed by a processor of a computer system, cause the computer system to perform method 1900. Method 1900 may include a number of steps, some of which may be optional:

Step 1901. A new shared key is generated for a user and a hospital information system with a shared key to be updated, and the new shared key is encrypted by using a shared key currently used by the user and the hospital information system.

Step 1902. A shared key update request is sent to an electronic prescription management system, the request carrying an identifier of the user, an identifier of the hospital information system and the encrypted new shared key, in which at least the encrypted new shared key is encrypted by using a shared quantum key between the client terminal and the electronic prescription management system.

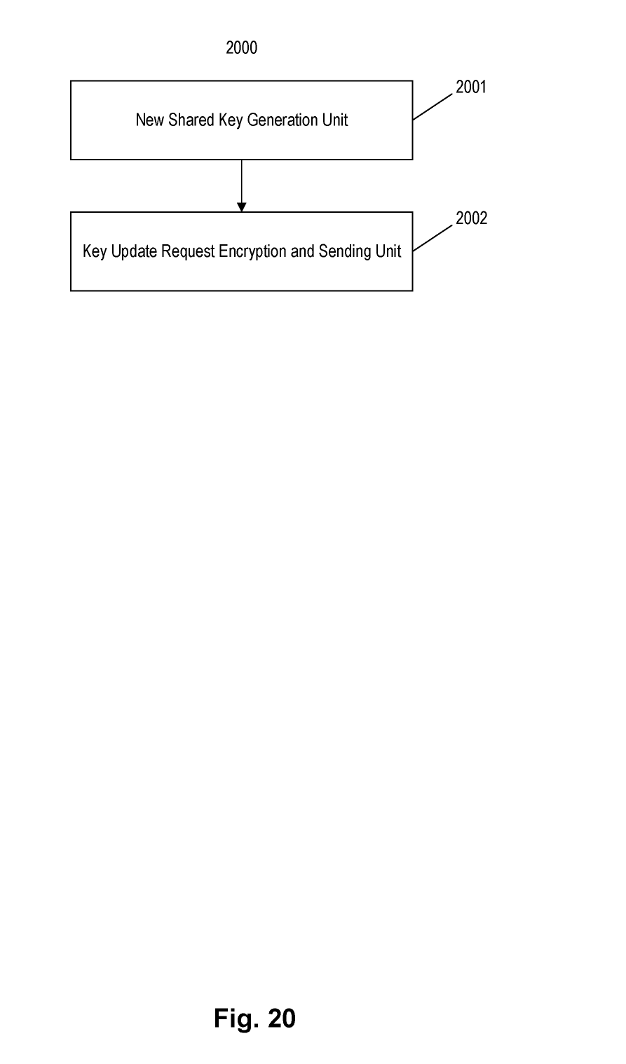

In the above embodiment, a request method for updating a shared key is disclosed. Correspondingly, a request apparatus for updating a shared key is disclosed below. FIG. 20 is a block diagram illustrating a request apparatus 2000 for updating a shared key, according to an exemplary embodiment. The apparatus embodiment described below is merely schematic.

Apparatus 2000 can be deployed at a client terminal and may include: a new shared key generation unit 2001 configured to generate a new shared key for a user and a hospital information system with a shared key to be updated, and encrypt the new shared key by using a shared key currently used by the user and the hospital information system; and a key update request encryption and sending unit 2002 configured to send a shared key update request to an electronic prescription management system, the request carrying an identifier of the user, an identifier of the hospital information system, and the encrypted new shared key, in which at least the encrypted new shared key is encrypted by using a shared quantum key between the client terminal and the electronic prescription management system.

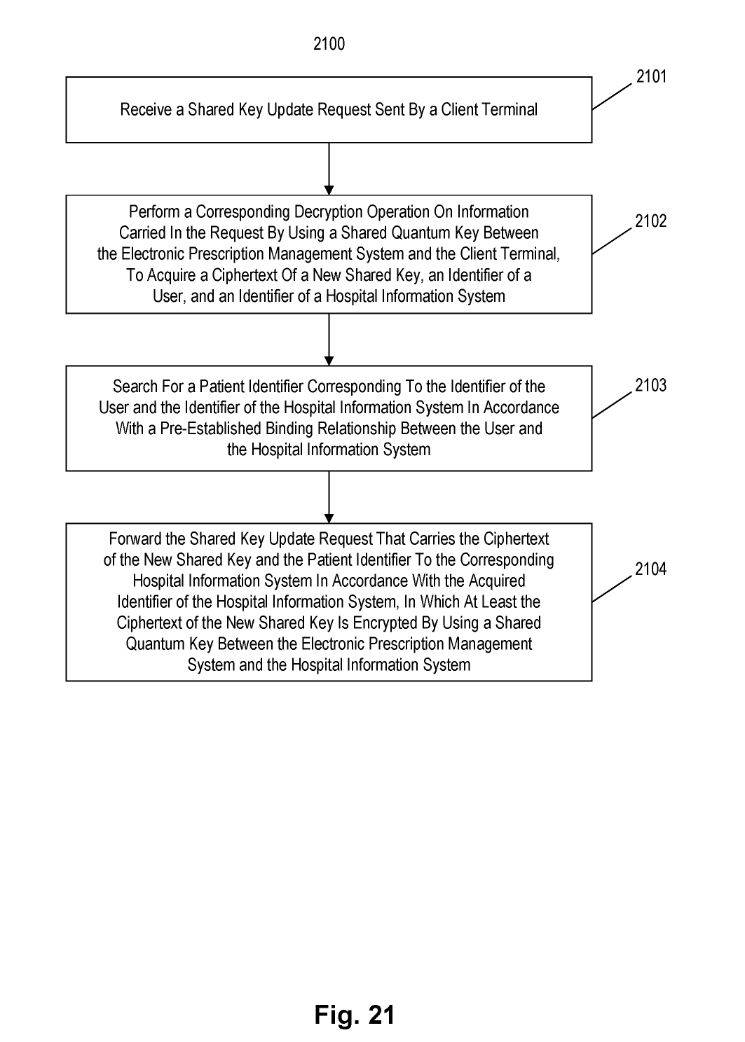

In addition, a method for forwarding a shared key update request is disclosed, and the method can be implemented in an electronic prescription management system. FIG. 21 is a flow diagram illustrating a method 2100 for forwarding a shared key update request, according to an exemplary embodiment. Contents of this embodiment similar to the embodiments described above are not repeated, and the following focuses on their differences. Method 2100 may be implemented by a non-transitory computer-readable storage medium storing one or more programs, the one or more programs comprising instructions which, when executed by a processor of a computer system, cause the computer system to perform method 2100. Method 2100 may include a number of steps, some of which may be optional:

Step 2101. A shared key update request sent by a client terminal is received.

Step 2102. A corresponding decryption operation is performed on information carried in the request by using a shared quantum key between the electronic prescription management system and the client terminal, to acquire a ciphertext of a new shared key, an identifier of a user, and an identifier of a hospital information system.

Step 2103. A patient identifier corresponding to the identifier of the user and the identifier of the hospital information system is searched in accordance with a pre-established binding relationship between the user and the hospital information system.

Step 2104. The shared key update request that carries the ciphertext of the new shared key and the patient identifier is forwarded to the corresponding hospital information system in accordance with the acquired identifier of the hospital information system, in which at least the ciphertext of the new shared key is encrypted by using a shared quantum key between the electronic prescription management system and the hospital information system.

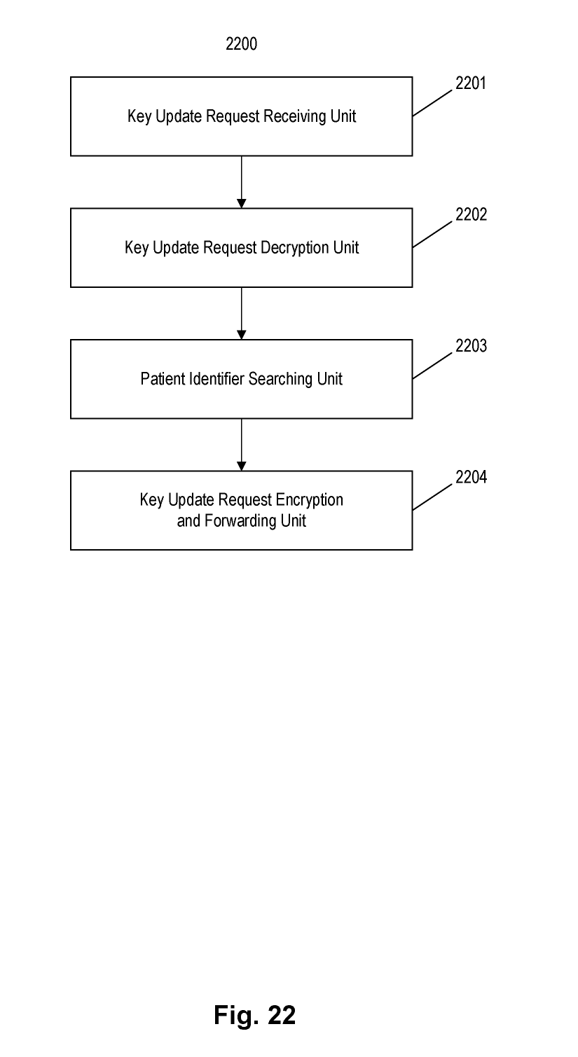

In the above embodiment, a method for forwarding a shared key update request is disclosed. Correspondingly, an apparatus for forwarding a shared key update request is disclosed below. FIG. 22 is a block diagram illustrating an apparatus 2200 for forwarding a shared key update request, according to an exemplary embodiment. The apparatus embodiment described below is merely schematic.

Apparatus 2200 can be deployed at an electronic prescription management system and may include: a key update request receiving unit 2201 configured to receive a shared key update request sent by a client terminal; a key update request decryption unit 2202 configured to perform a corresponding decryption operation on information carried in the request by using a shared quantum key between the electronic prescription management system and the client terminal, to acquire a ciphertext of a new shared key, an identifier of a user, and an identifier of a hospital information system; a patient identifier searching unit 2203 configured to search for a patient identifier corresponding to the identifier of the user and the identifier of the hospital information system in accordance with a pre-established binding relationship between the user and the hospital information system; and a key update request encryption and forwarding unit 2204 configured to forward the shared key update request that carries the ciphertext of the new shared key and the patient identifier to the corresponding hospital information system in accordance with the acquired identifier of the hospital information system, in which at least the ciphertext of the new shared key is encrypted by using a shared quantum key between the electronic prescription management system and the hospital information system.

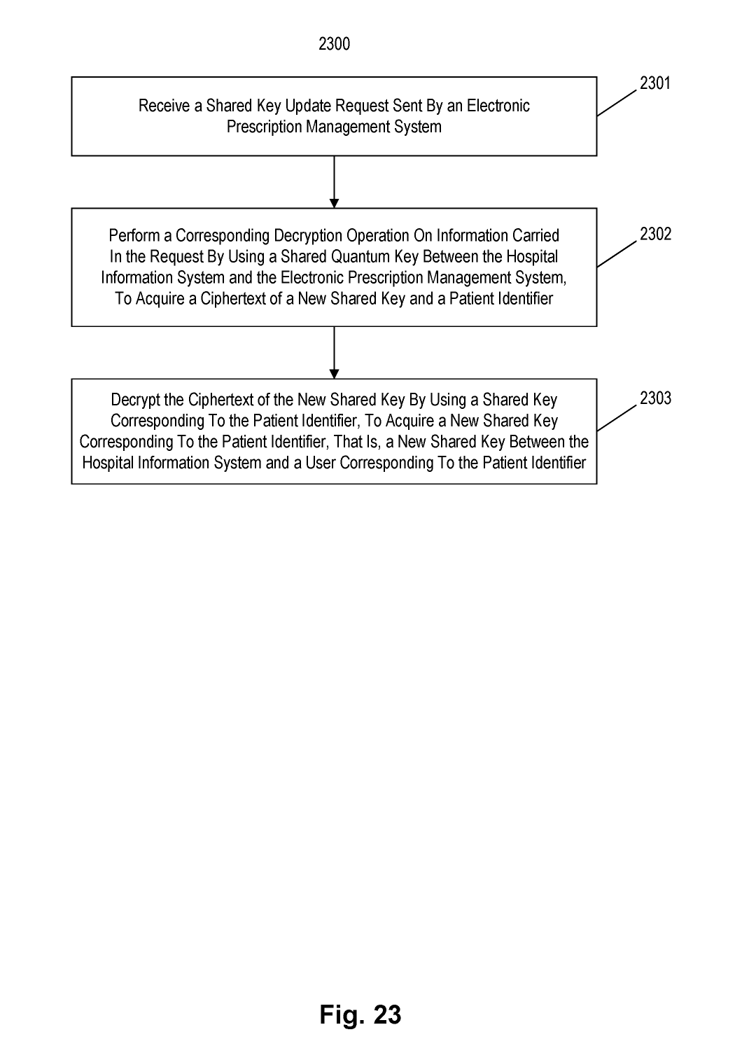

In addition, a method for updating a shared key is disclosed, and the method may be implemented in a hospital information system. FIG. 23 is a flow diagram illustrating a method 2300 for updating a shared key, according to an exemplary embodiment. Contents of this embodiment similar to the embodiments described above are not repeated, and the following focuses on their differences. Method 2300 may be implemented by a non-transitory computer-readable storage medium storing one or more programs, the one or more programs comprising instructions which, when executed by a processor of a computer system, cause the computer system to perform method 2300. Method 2300 may include a number of steps, some of which may be optional:

Step 2301. A shared key update request sent by an electronic prescription management system is received.

Step 2302. A corresponding decryption operation is performed on information carried in the request by using a shared quantum key between the hospital information system and the electronic prescription management system, to acquire a ciphertext of a new shared key and a patient identifier.

Step 2303. The ciphertext of the new shared key is decrypted by using a shared key corresponding to the patient identifier, to acquire a new shared key corresponding to the patient identifier, that is, a new shared key between the hospital information system and a user corresponding to the patient identifier.

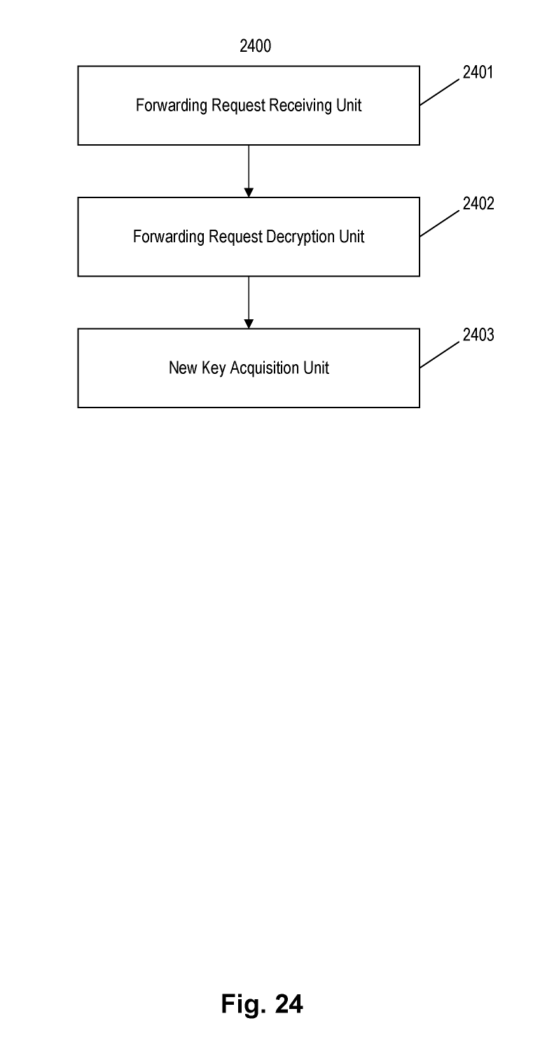

In the above embodiment, a method for updating a shared key is disclosed. Correspondingly, an apparatus for updating a shared key is disclosed below. FIG. 24 is a block diagram illustrating an apparatus 2400 for updating a shared key, according to an exemplary embodiment. The apparatus embodiment described below is merely schematic.

Apparatus 2400 can be deployed at a hospital information system and may include: a forwarding request receiving unit 2401 configured to receive a shared key update request sent by an electronic prescription management system; a forwarding request decryption unit 2402 configured to perform a corresponding decryption operation on information carried in the request by using a shared quantum key between the hospital information system and the electronic prescription management system, to acquire a ciphertext of a new shared key and a patient identifier; and a new key acquisition unit 2403 configured to decrypt the ciphertext of the new shared key by using a shared key corresponding to the patient identifier, to acquire a new shared key corresponding to the patient identifier, e.g., a new shared key between the hospital information system and a user corresponding to the patient identifier.

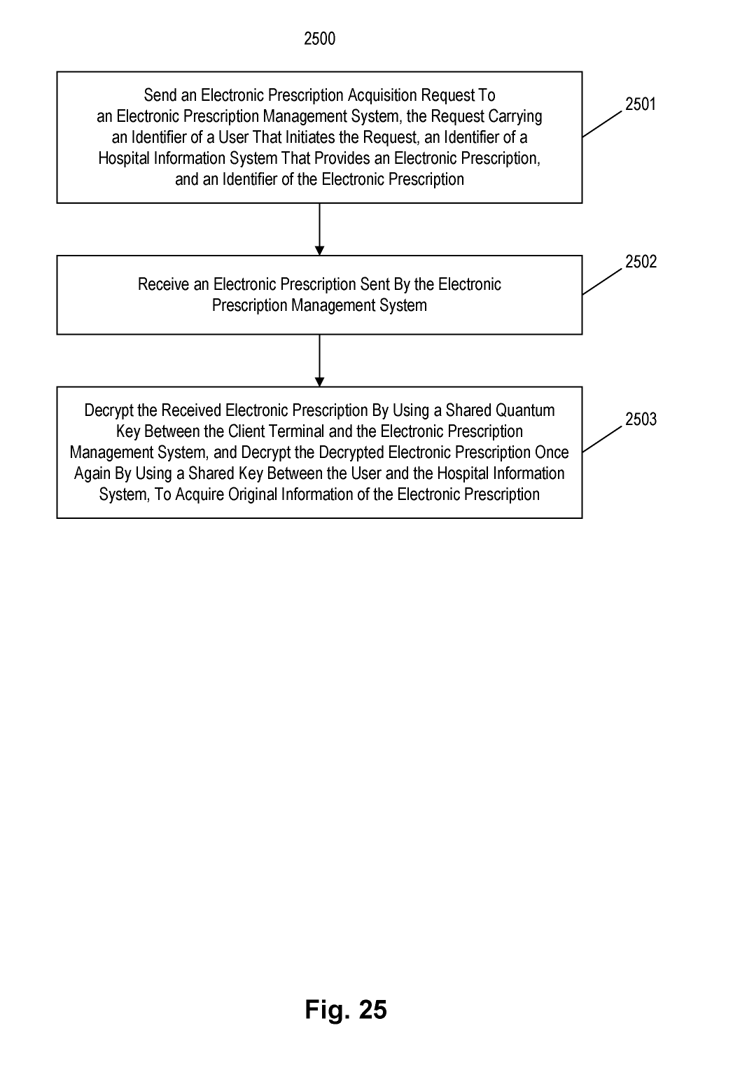

In addition, a request method for acquiring an electronic prescription is disclosed, and the method can be implemented at a client terminal. FIG. 25 is a flow diagram illustrating a request method 2500 for acquiring an electronic prescription, according to an exemplary embodiment. Contents of this embodiment similar to the embodiments described above are not repeated, and the following focuses on their differences. Method 2500 may be implemented by a non-transitory computer-readable storage medium storing one or more programs, the one or more programs comprising instructions which, when executed by a processor of a computer system, cause the computer system to perform method 2500. Method 2500 may include a number of steps, some of which may be optional:

Step 2501. An electronic prescription acquisition request is sent to an electronic prescription management system, the request carrying an identifier of a user that initiates the request, an identifier of a hospital information system that provides an electronic prescription, and an identifier of the electronic prescription.

Step 2502. An electronic prescription sent by the electronic prescription management system is received.

Step 2503. The received electronic prescription is decrypted by using a shared quantum key between the client terminal and the electronic prescription management system, and the decrypted electronic prescription is decrypted once again by using a shared key between the user and the hospital information system, to acquire original information of the electronic prescription.

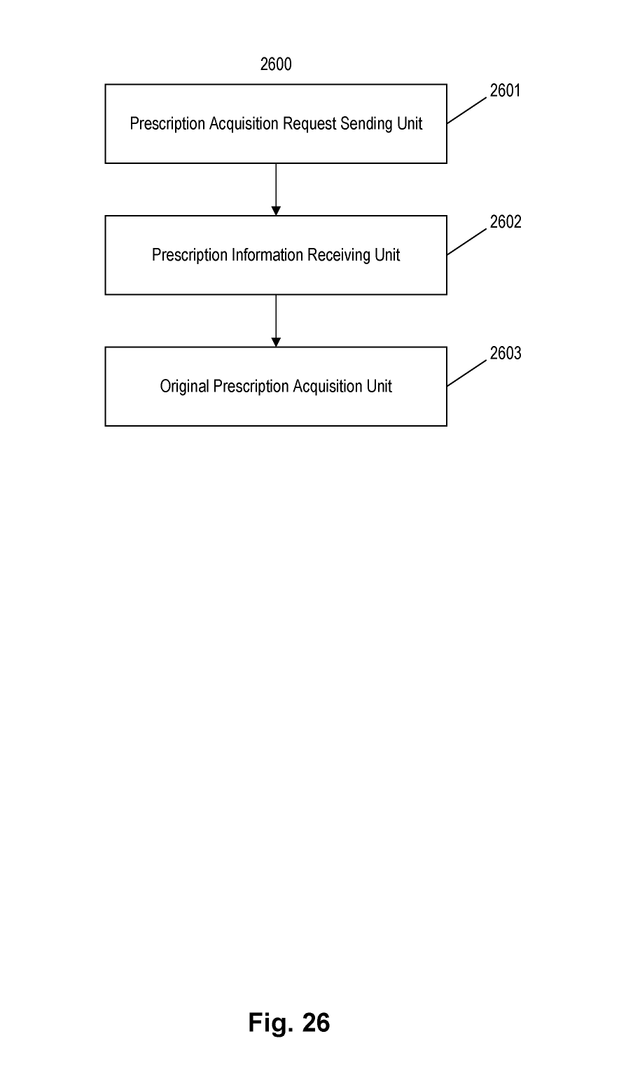

In the above embodiment, a request method for acquiring an electronic prescription is disclosed. Correspondingly, a request apparatus for acquiring an electronic prescription is disclosed below. FIG. 26 is a block diagram illustrating a request apparatus 2600 for acquiring an electronic prescription, according to an exemplary embodiment. The apparatus embodiment described below is merely schematic.

Apparatus 2600 can be deployed at a client terminal and may include: a prescription acquisition request sending unit 2601 configured to send an electronic prescription acquisition request to an electronic prescription management system, the request carrying an identifier of a user that initiates the request, an identifier of a hospital information system that provides an electronic prescription, and an identifier of the electronic prescription; a prescription information receiving unit 2602 configured to receive an electronic prescription sent by the electronic prescription management system; and an original prescription acquisition unit 2603 configured to decrypt the received electronic prescription by using a shared quantum key between the client terminal and the electronic prescription management system, and decrypt the decrypted electronic prescription once again by using a shared key between the user and the hospital information system, to acquire original information of the electronic prescription.

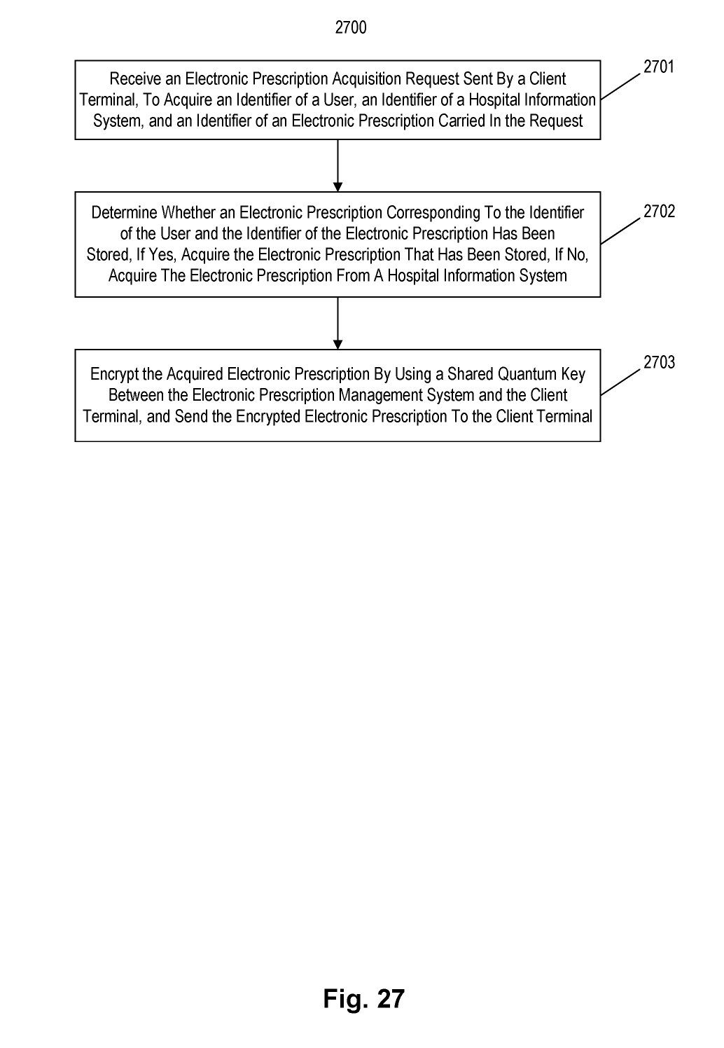

In addition, a method for forwarding an electronic prescription is disclosed, and the method can be implemented at an electronic prescription management system. FIG. 27 is a flow diagram illustrating a method 2700 for forwarding an electronic prescription, according to an exemplary embodiment. Contents of this embodiment similar to the embodiments described above are not repeated, and the following focuses on their differences. Method 2700 may be implemented by a non-transitory computer-readable storage medium storing one or more programs, the one or more programs comprising instructions which, when executed by a processor of a computer system, cause the computer system to perform method 2700. Method 2700 may include a number of steps, some of which may be optional:

Step 2701. An electronic prescription acquisition request sent by a client terminal is received, to acquire an identifier of a user, an identifier of a hospital information system, and an identifier of an electronic prescription carried in the request.

Step 2702. Whether an electronic prescription corresponding to the identifier of the user and the identifier of the electronic prescription has been stored is determined. If Yes, the electronic prescription that has been stored is acquired. If No, the electronic prescription is acquired from a hospital information system.

Acquiring the electronic prescription from the hospital information system may include the following processing process:

1) in accordance with a pre-established binding relationship between users and hospital information systems, a patient identifier corresponding to the identifier of the user and the identifier of the hospital information system is searched; and in accordance with the identifier of the hospital information system, the electronic prescription acquisition request that carries the patient identifier and the identifier of the electronic prescription is sent to the corresponding hospital information system;

2) an electronic prescription sent by the hospital information system and corresponding to the identifier of the user and the identifier of the electronic prescription is received; and

3) the received electronic prescription is decrypted by using a shared quantum key between the electronic prescription management system and the hospital information system, to serve as the electronic prescription acquired from the hospital information system, and the electronic prescription is stored.

Step 2703. The acquired electronic prescription is encrypted by using a shared quantum key between the electronic prescription management system and the client terminal, and is sent to the client terminal.

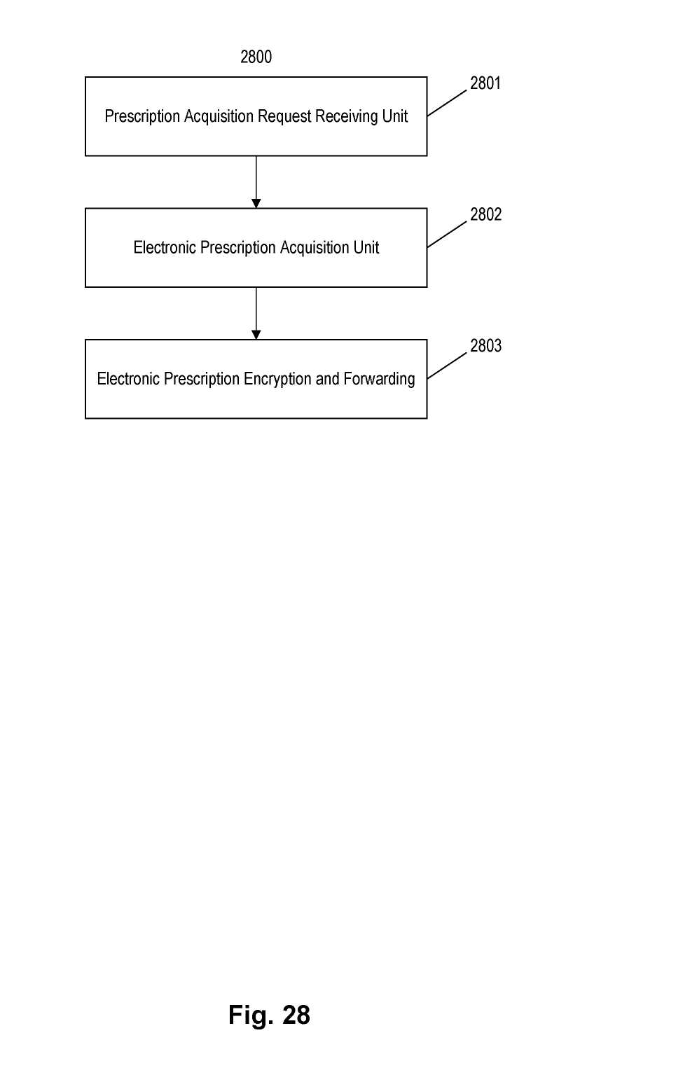

In the above embodiment, a method for forwarding an electronic prescription is disclosed. Correspondingly, an apparatus for forwarding an electronic prescription is disclosed below. FIG. 28 is a block diagram illustrating an apparatus 2800 for forwarding an electronic prescription, according to an exemplary embodiment. The apparatus embodiment described below is merely schematic.

Apparatus 2800 can be deployed at an electronic prescription management system and may include: a prescription acquisition request receiving unit 2801 configured to receive an electronic prescription acquisition request sent by a client terminal, to acquire an identifier of a user, an identifier of a hospital information system and an identifier of an electronic prescription carried in the request; an electronic prescription acquisition unit 2802 configured to determine whether an electronic prescription corresponding to the identifier of the user and the identifier of the electronic prescription has been stored; if Yes, acquire the electronic prescription that has been stored; if No, acquire the electronic prescription from a hospital information system; and an electronic prescription encryption and forwarding unit 2803 configured to encrypt the acquired electronic prescription by using a shared quantum key between the electronic prescription management system and the client terminal, and send the encrypted electronic prescription to the client terminal.

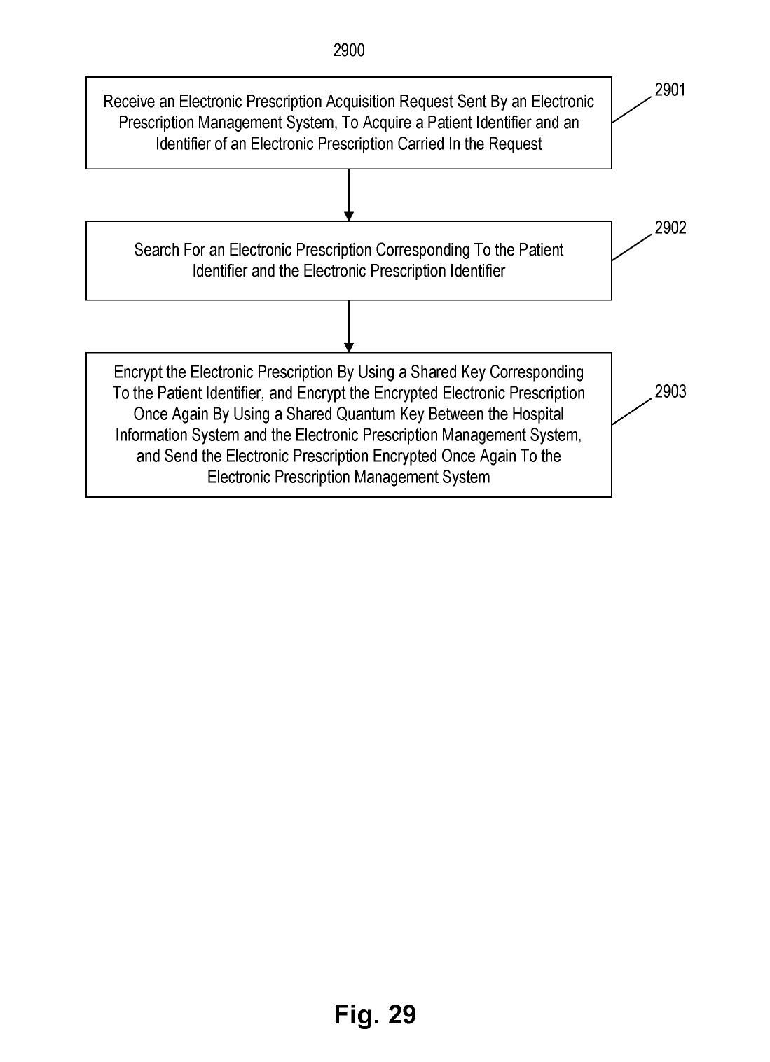

In addition, a method for providing an electronic prescription is disclosed, and the method can be implemented at a hospital information system. FIG. 29 is a flow diagram illustrating a method 2900 for providing an electronic prescription, according to an exemplary embodiment. Contents of this embodiment similar to the embodiments described above are not repeated, and the following focuses on their differences. Method 2900 may be implemented by a non-transitory computer-readable storage medium storing one or more programs, the one or more programs comprising instructions which, when executed by a processor of a computer system, cause the computer system to perform method 2900. Method 2900 may include a number of steps, some of which may be optional:

Step 2901. An electronic prescription acquisition request sent by an electronic prescription management system is received, to acquire a patient identifier and an identifier of an electronic prescription carried in the request.

Step 2902. An electronic prescription corresponding to the patient identifier and the identifier of the electronic prescription is searched.

Step 2903. The electronic prescription is encrypted by using a shared key corresponding to the patient identifier, and the encrypted electronic prescription is encrypted once again by using a shared quantum key between the hospital information system and the electronic prescription management system, and is sent to the electronic prescription management system.

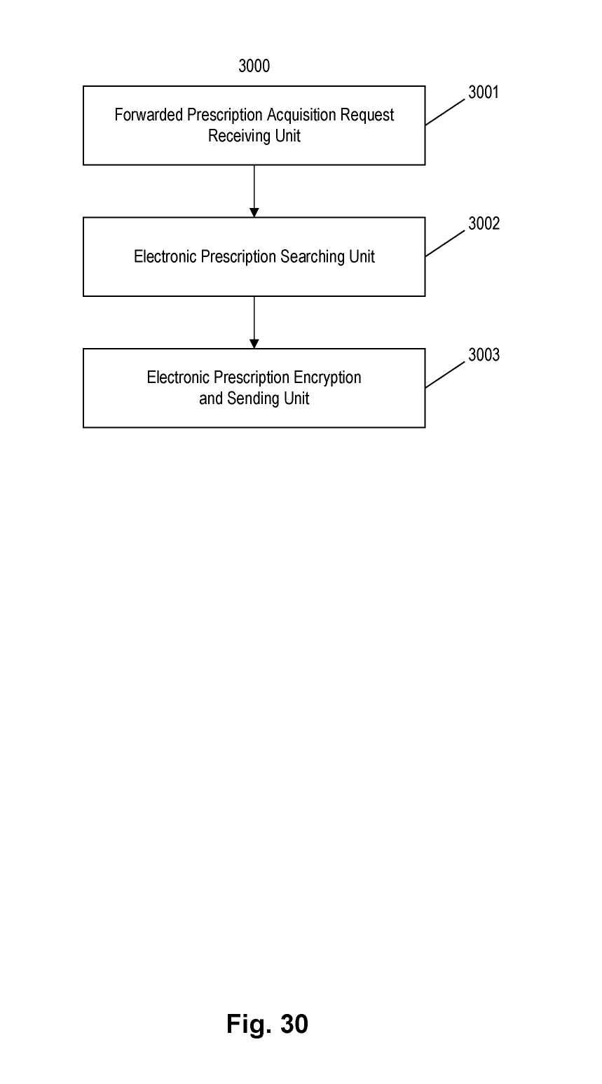

In the above embodiment, a method for providing an electronic prescription is disclosed. Correspondingly, an apparatus for providing an electronic prescription is disclosed below. FIG. 30 is a schematic diagram illustrating an apparatus 3000 for providing an electronic prescription, according to an exemplary embodiment. The apparatus embodiment described below is merely schematic.

Apparatus 3000 can be deployed at a hospital information system, and may include: a forwarded prescription acquisition request receiving unit 3001 configured to receive an electronic prescription acquisition request sent by an electronic prescription management system, to acquire a patient identifier and an identifier of an electronic prescription carried in the request; an electronic prescription searching unit 3002 configured to search for an electronic prescription corresponding to the patient identifier and the electronic prescription identifier; and an electronic prescription encryption and sending unit 3003 configured to encrypt the electronic prescription by using a shared key corresponding to the patient identifier, and encrypt the encrypted electronic prescription once again by using a shared quantum key between the hospital information system and the electronic prescription management system, and send the electronic prescription encrypted once again to the electronic prescription management system.

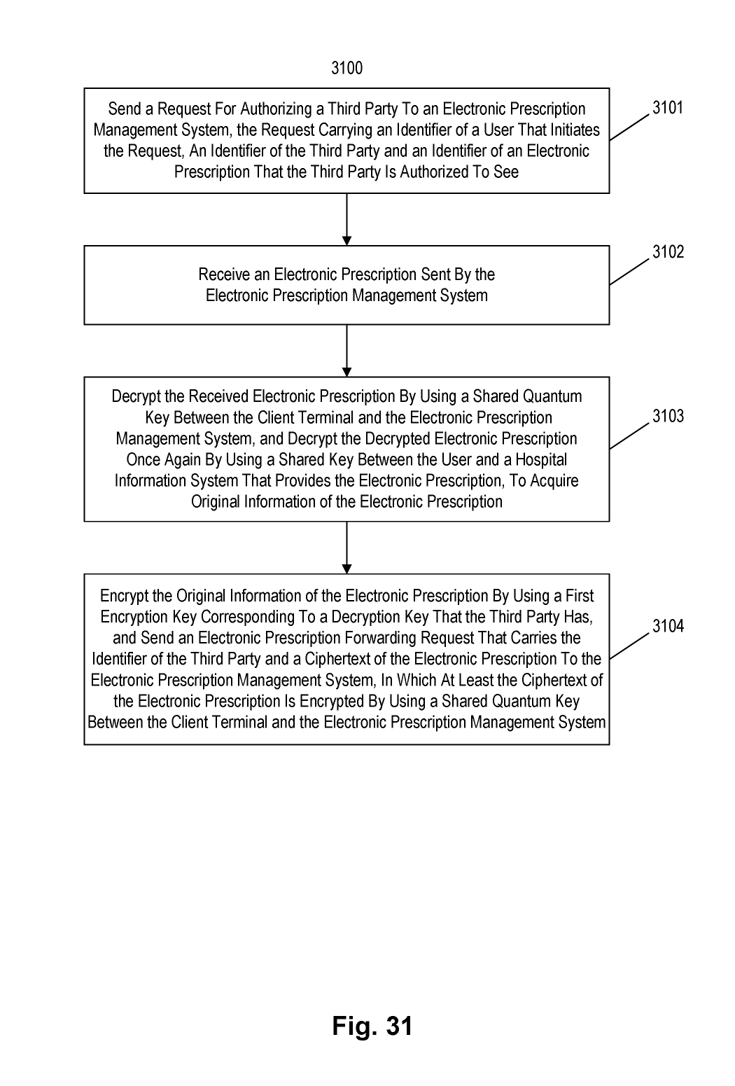

In addition, a request method for authorizing a third party is disclosed, and the method can be implemented at a client terminal. FIG. 31 is a flow diagram illustrating a request method 3100 for authorizing a third party, according to an exemplary embodiment. Contents of this embodiment similar to the embodiments described above are not repeated, and the following focuses on their differences. Method 3100 may be implemented by a non-transitory computer-readable storage medium storing one or more programs, the one or more programs comprising instructions which, when executed by a processor of a computer system, cause the computer system to perform method 3100. Method 3100 may include a number of steps, some of which may be optional:

Step 3101. A request for authorizing a third party is sent to an electronic prescription management system, the request carrying an identifier of a user that initiates the request, an identifier of the third party and an identifier of an electronic prescription that the third party is authorized to access/check.

Step 3102. An electronic prescription sent by the electronic prescription management system is received.

Step 3103. The received electronic prescription is decrypted by using a shared quantum key between the client terminal and the electronic prescription management system, and the decrypted electronic prescription is decrypted once again by using a shared key between the user and a hospital information system that provides the electronic prescription, to acquire original information of the electronic prescription.

Step 3104. The original information of the electronic prescription is encrypted by using a first encryption key corresponding to a decryption key that the third party has, and an electronic prescription forwarding request that carries the identifier of the third party and a ciphertext of the electronic prescription is sent to the electronic prescription management system, in which at least the ciphertext of the electronic prescription is encrypted by using a shared quantum key between the client terminal and the electronic prescription management system.

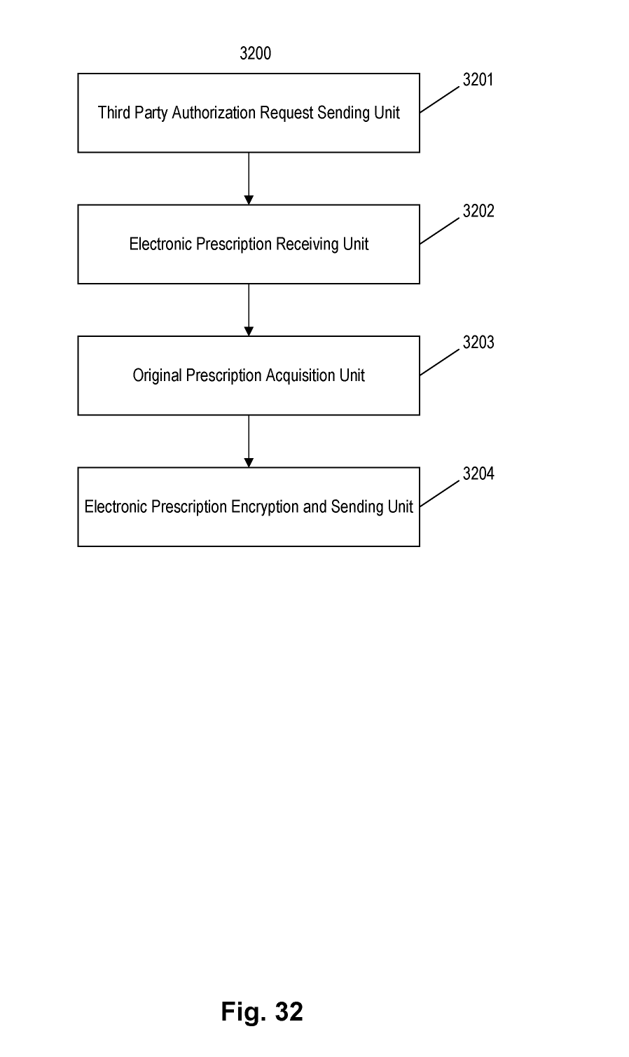

In the above embodiment, a request method for authorizing a third party is disclosed. Correspondingly, a request apparatus for authorizing a third party is disclosed below. FIG. 32 is a schematic diagram illustrating a request apparatus 3200 for authorizing a third party, according to an exemplary embodiment. The apparatus embodiment described below is merely schematic.

Apparatus 3200 can be deployed at a client terminal and may include: a third party authorization request sending unit 3201 configured to send a request for authorizing a third party to an electronic prescription management system, the request carrying an identifier of a user that initiates the request, an identifier of the third party and an identifier of an electronic prescription that the third party is authorized to access/check; an electronic prescription receiving unit 3202 configured to receive an electronic prescription sent by the electronic prescription management system; an original prescription acquisition unit 3203 configured to decrypt the received electronic prescription by using a shared quantum key between the client terminal and the electronic prescription management system, and decrypt the decrypted electronic prescription once again by using a shared key between the user and a hospital information system that provides the electronic prescription, to acquire original information of the electronic prescription; and an electronic prescription encryption and sending unit 3204 configured to encrypt the original information of the electronic prescription by using a first encryption key corresponding to a decryption key that the third party has, and send an electronic prescription forwarding request that carries the identifier of the third party and a ciphertext of the electronic prescription to the electronic prescription management system, in which at least the ciphertext of the electronic prescription is encrypted by using a shared quantum key between the client terminal and the electronic prescription management system.

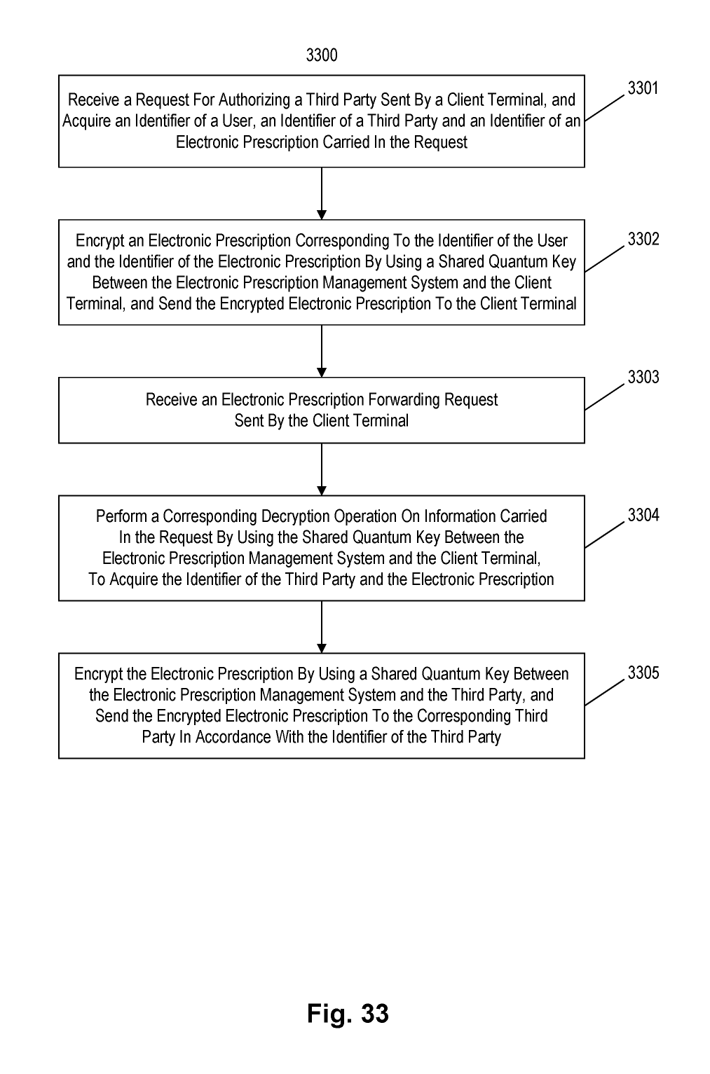

In addition, an electronic prescription forwarding method for authorizing a third party is disclosed, and the method can be implemented in an electronic prescription management system. FIG. 33 is a flow diagram illustrating an electronic prescription forwarding method 3300 for authorizing a third party, according to an exemplary embodiment. Contents of this embodiment similar to the embodiments described above are not repeated, and the following focuses on their differences. Method 3300 may be implemented by a non-transitory computer-readable storage medium storing one or more programs, the one or more programs comprising instructions which, when executed by a processor of a computer system, cause the computer system to perform method 3300. Method 3300 may include a number of steps, some of which may be optional:

Step 3301. A request for authorizing a third party sent by a client terminal is received, and an identifier of a user, an identifier of a third party and an identifier of an electronic prescription carried in the request are acquired.

Step 3302. An electronic prescription corresponding to the identifier of the user and the identifier of the electronic prescription is encrypted by using a shared quantum key between the electronic prescription management system and the client terminal, and is sent to the client terminal.

Step 3303. An electronic prescription forwarding request sent by the client terminal is received.

Step 3304. A corresponding decryption operation is performed on information carried in the request by using the shared quantum key between the electronic prescription management system and the client terminal, to acquire the identifier of the third party and the electronic prescription.

Step 3305. The electronic prescription is encrypted by using a shared quantum key between the electronic prescription management system and the third party, and the encrypted electronic prescription is sent to the corresponding third party in accordance with the identifier of the third party.

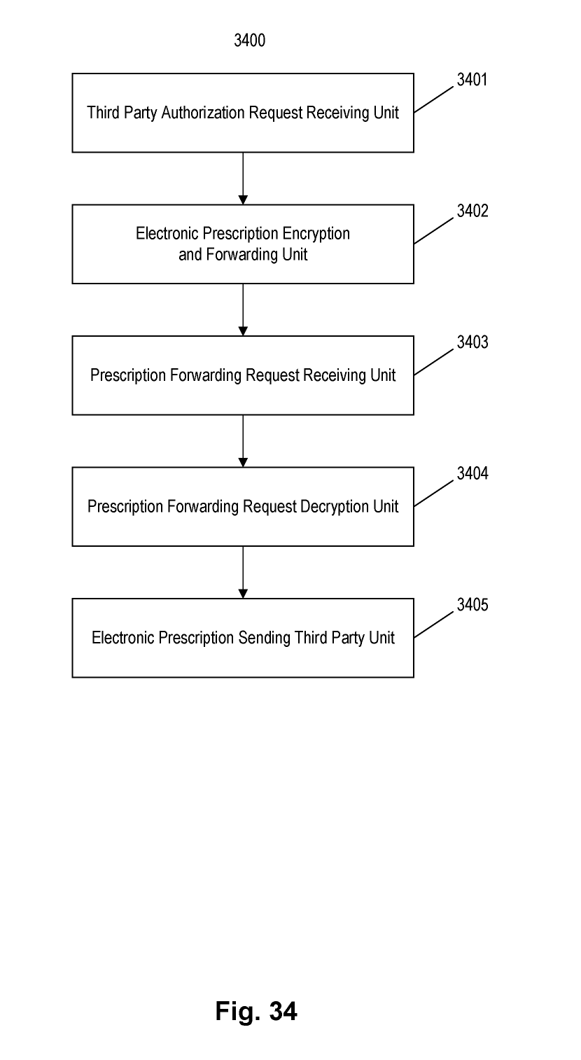

In the above embodiment, an electronic prescription forwarding method for authorizing a third party is disclosed. Correspondingly, an electronic prescription forwarding apparatus for authorizing a third party is disclosed below. FIG. 34 is a schematic diagram illustrating an electronic prescription forwarding apparatus 3400 for authorizing a third party according to the present application. The apparatus embodiment described below is merely schematic.

Apparatus 3400 can be deployed at an electronic prescription management system and may include: a third party authorization request receiving unit 3401 configured to receive a request for authorizing a third party sent by a client terminal, and acquire an identifier of a user, an identifier of a third party and an identifier of an electronic prescription carried in the request; an electronic prescription encryption and forwarding unit 3402 configured to encrypt an electronic prescription corresponding to the identifier of the user and the identifier of the electronic prescription by using a shared quantum key between the electronic prescription management system and the client terminal, and send the encrypted electronic prescription to the client terminal; a prescription forwarding request receiving unit 3403 configured to receive an electronic prescription forwarding request sent by the client terminal; a prescription forwarding request decryption unit 3404 configured to perform a corresponding decryption operation on information carried in the request by using the shared quantum key between the electronic prescription management system and the client terminal, to acquire the identifier of the third party and the electronic prescription; and an electronic prescription sending unit 3405 configured to encrypt the electronic prescription by using a shared quantum key between the electronic prescription management system and the third party, and send the encrypted electronic prescription to the corresponding third party in accordance with the identifier of the third party.

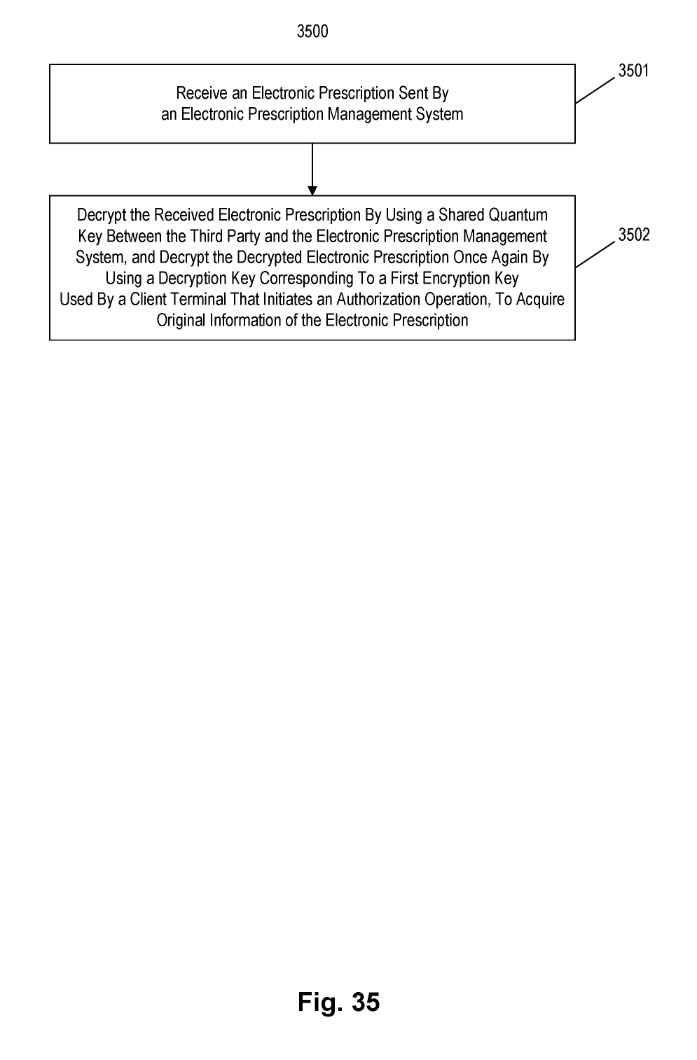

In addition, a method for acquiring an authorized prescription is disclosed, and the method can be implemented at a third party. FIG. 35 is a flow diagram illustrating a method 3500 for acquiring an authorized prescription, according to an exemplary embodiment. Contents of this embodiment similar to the embodiments described above are not repeated, and the following focuses on their differences. Method 3500 may be implemented by a non-transitory computer-readable storage medium storing one or more programs, the one or more programs comprising instructions which, when executed by a processor of a computer system, cause the computer system to perform method 3500. Method 3500 may include a number of steps, some of which may be optional:

Step 3501. An electronic prescription sent by an electronic prescription management system is received.

Step 3502. The received electronic prescription is decrypted by using a shared quantum key between the third party and the electronic prescription management system, and the decrypted electronic prescription is decrypted once again by using a decryption key corresponding to a first encryption key used by a client terminal that initiates an authorization operation, to acquire original information of the electronic prescription.

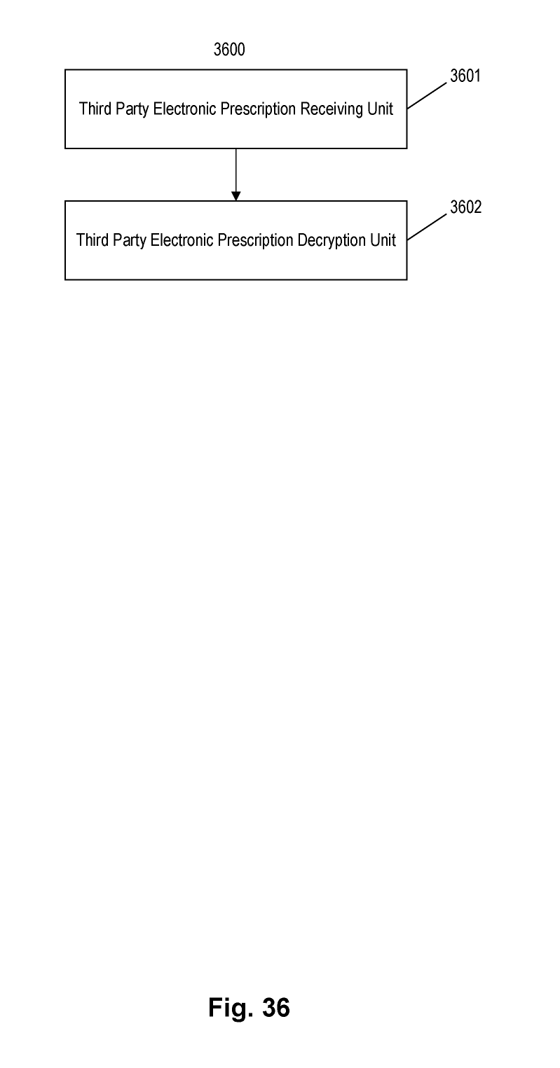

In the above embodiment, a method for acquiring an authorized prescription is disclosed. Correspondingly, an apparatus for acquiring an authorized prescription is disclosed below. FIG. 36 is a schematic diagram illustrating an apparatus 3600 for acquiring an authorized prescription, according to an exemplary embodiment. The apparatus embodiment described below is merely schematic.

Apparatus 3600 can be deployed at a third party and may include: a third party electronic prescription receiving unit 3601 configured to receive an electronic prescription sent by an electronic prescription management system; and a third party electronic prescription decryption unit 3602 configured to decrypt the received electronic prescription by using a shared quantum key between the third party and the electronic prescription management system, and decrypt the decrypted electronic prescription once again by using a decryption key corresponding to a first encryption key used by a client terminal that initiates an authorization operation, to acquire original information of the electronic prescription.

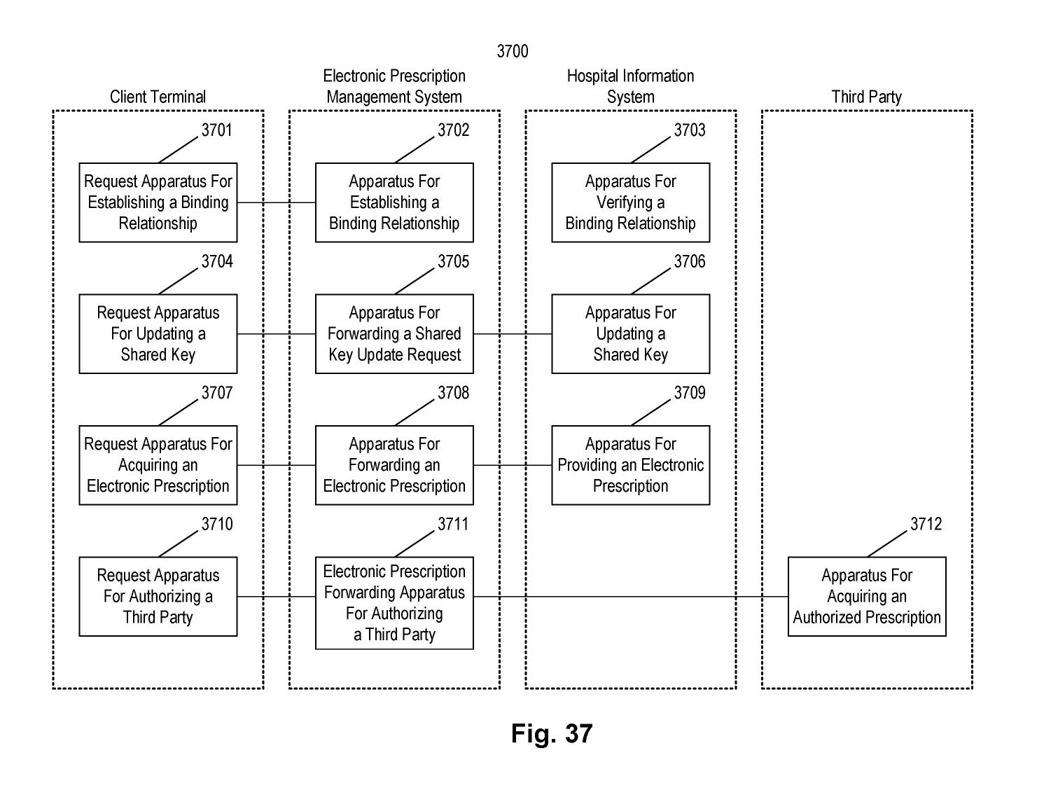

In addition, an electronic prescription operation system is disclosed. FIG. 37 is a block diagram illustrating an electronic prescription operation system 3700, according to an exemplary embodiment. The system may include the following four groups of apparatuses:

1) a request apparatus 3701 configured to establish a binding relationship, an apparatus 3702 configured to establish a binding relationship and an apparatus 3703 for verifying a binding relationship;

2) a request apparatus 3704 configured to update a shared key, an apparatus 3705 configured to forward a shared key update request and an apparatus 3706 for updating a shared key;

3) a request apparatus 3707 configured to acquire an electronic prescription, an apparatus 3708 configured to forward an electronic prescription and an apparatus 3709 for providing an electronic prescription; and

4) a request apparatus 3710 configured to authorize a third party, an electronic prescription forwarding apparatus 3711 configured to authorize a third party and an apparatus 3712 for acquiring an authorized prescription.

It should be noted that the electronic prescription operation system provided in this embodiment may include the above four groups of apparatuses, which may respectively correspond to the following four operations described in the first embodiment: establishing a binding relationship, updating a shared key, acquiring an electronic prescription, and authorizing a third party to access/check the electronic prescription. In some embodiments, the apparatuses included in the electronic prescription operation system may be different from those in this embodiment, for example, several groups of the above four groups of apparatuses may be included according to application demands, for example, only including the first group of apparatuses and the third group of apparatuses.

A person skilled in the art can further understand that, various exemplary logic blocks, modules, circuits, and algorithm steps described with reference to the disclosure herein may be implemented as electronic hardware, computer software, or a combination of electronic hardware and computer software. For examples, the modules/units may be implemented by a processor executing software instructions stored in the computer-readable storage medium.

The flowcharts and block diagrams in the accompanying drawings show system architectures, functions, and operations of possible implementations of the system and method according to multiple embodiments of the present invention. In this regard, each block in the flowchart or block diagram may represent one module, one program segment, or a part of code, where the module, the program segment, or the part of code includes one or more executable instructions used for implementing specified logic functions. It should also be noted that, in some alternative implementations, functions marked in the blocks may also occur in a sequence different from the sequence marked in the drawing. For example, two consecutive blocks actually can be executed in parallel substantially, and sometimes, they can also be executed in reverse order, which depends on the functions involved. Each block in the block diagram and/or flowchart, and a combination of blocks in the block diagram and/or flowchart, may be implemented by a dedicated hardware-based system for executing corresponding functions or operations, or may be implemented by a combination of dedicated hardware and computer instructions.

As will be understood by those skilled in the art, embodiments of the present disclosure may be embodied as a method, a system or a computer program product. Accordingly, embodiments of the present disclosure may take the form of an entirely hardware embodiment, an entirely software embodiment or an embodiment combining software and hardware. Furthermore, embodiments of the present disclosure may take the form of a computer program product embodied in one or more computer-readable storage media (including but not limited to a magnetic disk memory, a CD-ROM, an optical memory and so on) containing computer-readable program codes.

Embodiments of the present disclosure are described with reference to flow diagrams and/or block diagrams of methods, devices (systems), and computer program products according to embodiments of the present disclosure. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a general-purpose computer, a special-purpose computer, an embedded processor, or other programmable data processing devices to produce a machine, such that the instructions, which are executed via the processor of the computer or other programmable data processing devices, create a means for implementing the functions specified in one or more flows in the flow diagrams and/or one or more blocks in the block diagrams.

These computer program instructions may also be stored in a computer-readable memory that can direct a computer or other programmable data processing devices to function in a particular manner, such that the instructions stored in the computer-readable memory produce a manufactured product including an instruction means that implements the functions specified in one or more flows in the flow diagrams and/or one or more blocks in the block diagrams.

These computer program instructions may also be loaded onto a computer or other programmable data processing devices to cause a series of operational steps to be performed on the computer or other programmable devices to produce processing implemented by the computer, such that the instructions which are executed on the computer or other programmable devices provide steps for implementing the functions specified in one or more flows in the flow diagrams and/or one or more blocks in the block diagrams. In a typical configuration, a computer device includes one or more Central Processing Units (CPUs), an input/output interface, a network interface, and a memory. The memory may include forms of a volatile memory, a random access memory (RAM), and/or non-volatile memory and the like, such as a read-only memory (ROM) or a flash RAM in a computer-readable storage medium. The memory is an example of the computer-readable storage medium.

The computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The computer-readable storage medium includes non-volatile and volatile media, and removable and non-removable media, wherein information storage can be implemented with any method or technology. Information may be modules of computer-readable instructions, data structures and programs, or other data. Examples of a computer-readable storage medium include but are not limited to a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, tape or disk storage or other magnetic storage devices, or any other non-transmission media that may be used to store information capable of being accessed by a computer device. The computer-readable storage medium is non-transitory, and does not include transitory media, such as modulated data signals and carrier waves.

The specification has described methods, apparatus, and systems for electronic prescription. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with the disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. An electronic prescription operation method, comprising:
obtaining, by an electronic prescription management system, an electronic prescription operation request of a user from a client terminal;
encrypting, by the electronic prescription management system and according to the operation request, private data of the user with a shared quantum key; and
transmitting, by the electronic prescription management system, the encrypted private data to a destination device according to the operation request,
wherein the shared quantum key is negotiated and acquired in advance by the electronic prescription management system and the destination device based on a quantum key distribution protocol.

2. The electronic prescription operation method of claim 1, wherein the private data comprises at least one of: a first shared key between the user and a hospital information system, an electronic prescription of the user, and a second shared key between the user and a third party.

3. The electronic prescription operation method of claim 1, further comprising:
obtaining, by the electronic prescription management system, private data encrypted with a preset hash algorithm or with an encryption key inaccessible to the electronic prescription management system.

4. The electronic prescription operation method of claim 3, wherein the method further comprises:
obtaining, by the electronic prescription management system and from the client terminal, a binding relationship establishment request that includes a hash value of the private data, the hash value being generated based on the preset hash algorithm;
transmitting, by the electronic prescription management system to the hospital information system, a binding verification request that includes the hash value;
obtaining, by the electronic prescription management system from the hospital information system, a verification passing acknowledgement that indicates an identity of the user has been verified based on the hash value; and
establishing, by the electronic prescription management system, a binding relationship between the user and the hospital information system in accordance with the obtained verification passing acknowledgement,
wherein the electronic prescription operation request includes the binding relationship establishment request.

5. The electronic prescription operation method of claim 4, wherein the binding relationship establishment request includes the hash value, an identifier of the user, an identifier of the hospital information system with which the binding relationship is to be established, and a patient identifier of the user corresponding to the hospital information system;
wherein transmitting, by the electronic prescription management system, the binding verification request carrying the hash value to the hospital information system comprises:
determining, based on the identifier of the hospital information system included in the binding relationship establishment request, a hospital information system to receive a second binding verification request that includes the hash value and the patient identifier, and
transmitting, by the electronic prescription management system, the second binding verification request to the determined hospital information system;
and wherein establishing, by the electronic prescription management system, the binding relationship between the user and the hospital information system comprises:
establishing a mapping relationship among the identifier of the user, the identifier of the hospital information system, and the patient identifier.

6. The electronic prescription operation method of claim 5, wherein the private data comprises: a shared key between the user and the hospital information system with which a binding relationship is to be established.

7. The electronic prescription operation method of claim 5, further comprising:
returning, by the electronic prescription management system, a binding success acknowledgement to the client terminal, after completing the binding operation.

8. The electronic prescription operation method of claim 7, wherein the binding relationship establishment request and the binding verification request include auxiliary authentication information;
wherein the verification passing acknowledgement is include encrypted variant information generated based on the auxiliary authentication information;
wherein the variant information is encrypted based on a shared key between the user and the hospital information system; and
wherein the binding success acknowledgement also includes the encrypted variant information.

9. The electronic prescription operation method of claim 8, wherein the variant information of the auxiliary authentication information comprises one of:
the auxiliary authentication information; or
second information based on a transformation of the auxiliary authentication information with a preset mathematical transformation method.

10. The electronic prescription operation method of claim 3, wherein the electronic prescription operation request includes a shared key update request; and
wherein the method further comprises:
obtaining, by the electronic prescription management system and from the client terminal, a shared key update request that includes an encrypted new shared key, wherein the encrypted new shared key is encrypted with a shared key associated with the user and the hospital information system, and
transmitting, by the electronic prescription management system, the shared key update request to the hospital information system, after receiving the shared key update request.

11. The electronic prescription operation method of claim 10, wherein the shared key update request further includes an identifier of the user and an identifier of the hospital information system; and
wherein transmitting, by the electronic prescription management system, the shared key update request to the hospital information system comprises:
determining, based on the identifier of the hospital information system included in the shared key update request, a hospital information system to receive a second shared key update request that includes the encrypted new shared key and a patient identifier, and
transmitting the second shared key update request to the determined hospital information system;

12. The electronic prescription operation method of claim 11, wherein transmitting, by the electronic prescription management system, the second shared key update request to the determined hospital information system further comprises:
determining the patient identifier based on the identifier of the user, the identifier of the determined hospital information system, and a pre-established binding relationship between users and hospital information systems.

13. The electronic prescription operation method of claim 11, wherein the new shared key is a random number.

14. The electronic prescription operation method of claim 1, wherein the electronic prescription operation request includes an electronic prescription acquisition request; wherein the method further comprises:
after receiving the electronic prescription acquisition request, transmitting, to the client terminal, an electronic prescription acquired from a hospital information system, the electronic prescription being encrypted with a shared key between the user and the hospital information system that provides the electronic prescription.

15. The electronic prescription operation method of claim 14, further comprising updating the shared key by the electronic prescription management system.

16. The electronic prescription operation method of claim 14, wherein the electronic prescription acquisition request obtained from the client terminal includes an identifier of the user, an identifier of the hospital information system that provides the electronic prescription, and an identifier of electronic prescription; and
wherein the electronic prescription transmitted to the client device corresponds to the identifier of the user and to the identifier of electronic prescription included in the electronic prescription acquisition request.

17. The electronic prescription operation method of claim 16, wherein transmitting, by the electronic prescription management system to the client terminal, an electronic prescription acquired from a hospital information system comprises:
determining whether an electronic prescription corresponding to the identifier of the user and the identifier of electronic prescription has been stored, and
after determining that the electronic prescription corresponding to the identifier of the user and the identifier of the electronic prescription has been stored, acquiring the electronic prescription and transmitting the acquired electronic prescription to the client terminal.

18. The electronic prescription operation method of claim 17, wherein transmitting, by the electronic prescription management system to the client terminal, an electronic prescription acquired from a hospital information system comprises:
after determining that the electronic prescription corresponding to the identifier of the user and the identifier of the electronic prescription has not been stored, acquiring a patient identifier corresponding to the identifier of the user and the identifier of the hospital information system based on a pre-established binding relationship between the user and the hospital information system,
determining, based on the identifier of the hospital information system included in the electronic prescription acquisition request, a hospital information system to receive a second electronic prescription acquisition request that includes the patient identifier and the identifier of electronic prescription,
transmitting the second electronic prescription acquisition request to the determined hospital information system,
obtaining, from the determined hospital information system, the electronic prescription encrypted with a shared key between the determined hospital information system and the user,
storing the obtained electronic prescription and corresponding to the identifier of the user and the identifier of the electronic prescription, and
transmitting the stored electronic prescription to the client terminal.

19. The electronic prescription operation method of claim 1, wherein the electronic prescription operation request includes a third party authorization request; and
wherein the method further comprises:
after obtaining the third party authorization request, transmitting, by the electronic prescription management system, an electronic prescription that the third party is authorized to access to the client terminal, the electronic prescription being encrypted with a shared key between the user and a hospital information system that provides the electronic prescription,
obtaining, by the electronic prescription management system and from the client terminal, an electronic prescription forwarding request that includes original information of the electronic prescription encrypted with a first encryption key corresponding to a decryption key, and
transmitting, by the electronic prescription management system to the third party, the received encrypted electronic prescription.

20. The electronic prescription operation method of claim 19, wherein:
the first encryption key comprises a public key of the third party; and
the decryption key comprises a private key of the third party.

21. The electronic prescription operation method of claim 19, wherein the third party authorization request includes an identifier of the user, an identifier of the third party, and an identifier of the electronic prescription that the third party is authorized to access;
wherein transmitting, by the electronic prescription management system, the electronic prescription that the third party is authorized to access to the client terminal comprises:
transmitting, by the electronic prescription management system, an electronic prescription acquired from the hospital information system that provides the electronic prescription and corresponding to the identifier of the user and the identifier of the electronic prescription to the client terminal;
wherein the electronic prescription forwarding request transmitted by the client terminal to the electronic prescription management system includes the encrypted electronic prescription and the identifier of the third party; and
wherein transmitting, by the electronic prescription management system, the encrypted electronic prescription received to the third party comprises:
acquiring the identifier of the third party from the electronic prescription, and
transmitting the electronic prescription to the corresponding third party based on with the identifier of the third party.

22. The electronic prescription operation method of claim 21, further comprising:
receiving, by the electronic prescription management system from the client terminal, an encrypted new shared key and the original information of the electronic prescription encrypted with the new shared key, wherein the new shared key is for processing a subsequent third party authorization request;
transmitting, by the electronic prescription management system to the third party, the encrypted new shared key and the electronic prescription encrypted with the new shared key, wherein the new shared key enables the third party to obtain the original information of the electronic prescription.

23. The electronic prescription operation method of claim 1, wherein data transmission among the interacting devices is based on HTTPS connection, and digital certificates used by the interacting devices are issued by a trusted third party.

24. The electronic prescription operation method of claim 1, further comprising, before negotiating the shared quantum key through the quantum key distribution protocol, performing, by the electronic prescription management system, a two-way identity authentication, wherein the negotiation process is started if the authentication is passed.

25. An electronic prescription management apparatus, comprising:
a memory that stores a set of instructions; and
one or more hardware processors configured to execute the set of instructions to:
obtain an electronic prescription operation request of a user from a client terminal;
encrypt, according to the operation request, private data of the user with a shared quantum key; and
transmit the encrypted private data to a destination device according to the operation request,
wherein the shared quantum key is negotiated and acquired in advance by the electronic prescription management system and the destination device based on a quantum key distribution protocol.

26. A non-transitory computer-readable storage medium storing one or more programs that, when executed by a processor of an electronic prescription management system, cause the electronic prescription management system to perform an electronic prescription operation, the method comprising:
obtaining, by an electronic prescription management system, an electronic prescription operation request of a user from a client terminal;
encrypting, by the electronic prescription management system and according to the operation request, private data of the user with a shared quantum key; and
transmitting, by the electronic prescription management system, the encrypted private data to a destination device according to the operation request,
wherein the shared quantum key is negotiated and acquired in advance by the electronic prescription management system and the destination device based on a quantum key distribution protocol.
